(19) United States
(12) Patent Application Publication
(10) Pub. No.: US 2026/0370616 A1
(43) Pub. Date: Nov. 19, 2026

(54) COLLECTIVE COMMUNICATION AUTOCONFIGURATION FOR NETWORKED SWITCHES

(71) Applicants: Przemyslaw R. Karpinski, Gdansk (PL); Michal Lewandowski, Gdansk (PL); Marek M. Landowski, Gdansk (PL); Lukasz Meller, Bojano (PL)

(72) Inventors: Przemyslaw R. Karpinski, Gdansk (PL); Michal Lewandowski, Gdansk (PL); Marek M. Landowski, Gdansk (PL); Lukasz Meller, Bojano (PL)

(21) Appl. No.: 19/721,887

(22) Filed: Jun. 26, 2026

(51) Int. Cl. H04L 49/111; H04L 49/00

(52) U.S. Cl. CPC H04L 49/111; H04L 49/3027

(57) ABSTRACT

Techniques are disclosed for configuring a device with integrated networked switches, using an aggregation tree to define data flow in collective communication operations such as allreduce. Before construction, each switch determines a priority vector by transmitting broadcast messages from terminal switches and recording the order in which ports receive them, approximating the order of directions towards nearest terminals. Construction is initiated from a root switch using a request message. A receiving switch explores its ports in a priority order determined by a port priority computed from each port's occupancy and priority value, then transmits additional request messages to connect further switches in a depth-first manner. Switches enter a configured state when terminal or having a designated port, and a rejected state otherwise, pruning branches that reach no terminal. Construction completes when all root switch ports are explored. The process repeats across virtual channels to embed multiple low-overlap trees.

### BACKGROUND

Modern processors and computing devices can integrate large numbers of compute elements, such as processor cores, accelerators, and memory controllers, on a single semiconductor die or within a single package. These compute elements often communicate with one another over an on-chip interconnect commonly referred to as a network-on-chip (NoC). A NoC involves a plurality of switches connected by physical links, where each switch is coupled to one or more compute elements and to one or more neighboring switches. A switch forwards data between its ports using a configuration that maps an input port to one or more output ports. Larger systems are formed by connecting multiple such devices over inter-die or inter-package links, extending the network of switches across a package, a board, a rack, or a data center.

One class of communication carried over a network of switches is Collective Communication (CC). High-performance computing (HPC), autonomous vehicles/robotics, edge/Internet of Things (IoT) solutions, and training and inference of artificial intelligence (AI) and machine learning (ML) workloads use CC primitives, especially in the context of model parameter reductions in data-parallel training and activation calculations during various types of distributed AI inference.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate, generally, by way of example, but not by way of limitation, various embodiments discussed in the present document.

FIG. 1 depicts a switch logic diagram of an example Steiner-priority gossip protocol implementation.

FIGS. 2A to 2F depict stages of implementing a gossip protocol in an example switch implementation.

FIG. 3 depicts a switch logic diagram of an example port scoring implementation.

FIG. 4 depicts a switch logic diagram of an example port-priority selection mechanism for aggregation tree autoconfiguration.

FIGS. 5A to 5I depict stages of aggregation tree construction with a port-priority selection mechanism in an example switch implementation.

FIG. 6 depicts a flowchart of a method for networked switch autoconfiguration.

FIG. 7A provides an overview of example components deployed at a computing device.

FIG. 7B provides a further overview of example components within a computing device.

### DETAILED DESCRIPTION

The following provides approaches for automatically configuring multiple minimally overlapping aggregation trees embedded in a network of switches, such as to support communication between processors or other compute nodes in a Network on Chip (NoC) design implemented by a System-on-Chip (SoC) or System-in-Package (SiP) semiconductor device. In such a device, a plurality of switches are interconnected by physical links to form the network, individual switches are coupled to compute elements such as processor cores or accelerators, and the switches forward Collective Communication (CC) traffic among the compute elements. A switch that is coupled to a compute element and that participates in a CC operation is referred to as a terminal switch, and a switch that forwards traffic between terminal switches without itself contributing data is referred to as a forwarding switch.

One use of aggregation trees in a network of switches is to maximize the performance of CC primitives, particularly for large-buffer allreduce operations. In an allreduce operation, the data contributed by multiple participating nodes is combined by an arithmetic reduction, and the combined result is distributed back to the participating nodes. The performance of large-buffer allreduce operations affects the time and energy cost of training and inference workloads. To perform an allreduce, the participating nodes are connected by a data path structure provided by an aggregation tree. The participating nodes correspond to terminal switches in the network, whereas switches along a path between terminal switches act as forwarding switches. Data flows from the participating nodes toward a root of the tree during a reduction phase, and from the root back toward the participating nodes during a broadcast phase.

An aggregation tree that connects a selected subset of terminal switches through a network, while omitting switches that do not lie on a path to a terminal switch, is a directed tree referred to as a Steiner arborescence. A Steiner arborescence is rooted at a root switch, directs data from the terminal switches toward the root along the reduction phase, and directs data from the root toward the terminal switches along the broadcast phase. The switches that are neither terminal nor on a path to a terminal are pruned from the tree so that they do not consume links or ports that could otherwise carry an independent tree.

The bandwidth of an allreduce operation carried on a single aggregation tree is bounded by the link in the tree with the lowest capacity. Where multiple aggregation trees are embedded over the same physical network of switches, the total available allreduce bandwidth can be increased, provided that the trees use independent network pathways. Where two or more trees share a common link, the trees contend for the bandwidth of that link, and the effective bandwidth available to each tree is reduced in proportion to the number of sharing trees.

The following disclosure includes techniques to address the technical problem of configuring aggregation trees for an arbitrary selection of terminal points in a switch-based network. These techniques also address technical problems arising in scenarios of distributed switch configuration, while removing the need for offline modeling and software manipulation of both NoC and aggregation topologies.

Another specific aspect of the following disclosure addresses the sub-problem of establishing a Steiner Distance Priority Vector (SDPV) on all switches in a network for use with these aggregation trees. An algorithm determines the ordering of each port by approximating the direction towards the nearest terminal switch (also referred to as a “terminal node”) of the network. This ordering can be later used to determine the order of network exploration when connecting all terminals via an aggregation tree autoconfiguration protocol.

Another specific aspect of the following disclosure addresses the sub-problem of heuristically selecting port priorities based on the SDPV and port occupancy, calculated as the number of aggregation trees/virtual channels already assigned to each port. The priority selection determines the order of network exploration during the construction of the aggregation tree.

Another specific aspect of the following disclosure addresses the sub-problem of negotiating the aggregation tree structure in the network of switches, by constructing a Steiner Arborescence (directed tree) connecting selected terminal switches. A Steiner arborescence is a directed tree rooted at a root switch that connects the selected terminal switches over the network while excluding switches that do not lie on a path between the root switch and a terminal switch. Constructing the arborescence in a distributed manner allows each switch to be configured using locally available information, without a central agent that holds a global representation of the network topology.

The following examples refer to the autoconfiguration of one or more aggregation trees embedded in a network of switches, where each aggregation tree connects a selected set of terminal switches through the network and is rooted at a root switch. An aggregation tree may be constructed in a distributed manner by finite state machines (FSMs) maintained at each switch and at each port of the switch. The FSMs exchange point-to-point messages with FSMs of neighboring switches to identify, for the aggregation tree, a root port that directs data toward the root switch during a reduction phase and one or more designated ports that direct data toward the terminal switches during a broadcast phase.

An autoconfiguration constructs the aggregation tree as a Steiner arborescence by exploring the network from the root switch, marking ports along the explored paths, and pruning branches that do not reach a terminal switch. Multiple aggregation trees can be embedded over the same network of switches, with each aggregation tree assigned to a respective virtual channel. This enables collective operations carried on the multiple aggregation trees, such as allreduce-class collective operations, to use independent network pathways and contend for shared links less frequently. As a result, these and related implementations can improve the performance of networking and processing in a variety of systems, while enabling improved features across a variety of use cases of computing, including but not limited to scenarios involving artificial intelligence (AI), security, robotics, and high-performance computing.

### Steiner-Priority Gossip Protocol for Collective Communication Autoconfiguration

In some examples, a Steiner-priority gossip protocol calculates the SDPV, where priorities correspond to the effective shortest paths to nearest terminal switches, visible from a given port. The mechanism of this gossip protocol includes the use of per-switch and per-port state machines, as well as a point-to-point messaging protocol. This gossip protocol establishes effective, approximate shortest paths under the current network load. The priorities can then be used to order the network exploration algorithms, such as those presented with in-network collective communication autoconfiguration protocols, and to offer dynamic adaptability to workload conditions, such as terminal switch selection or dynamically changing traffic conditions.

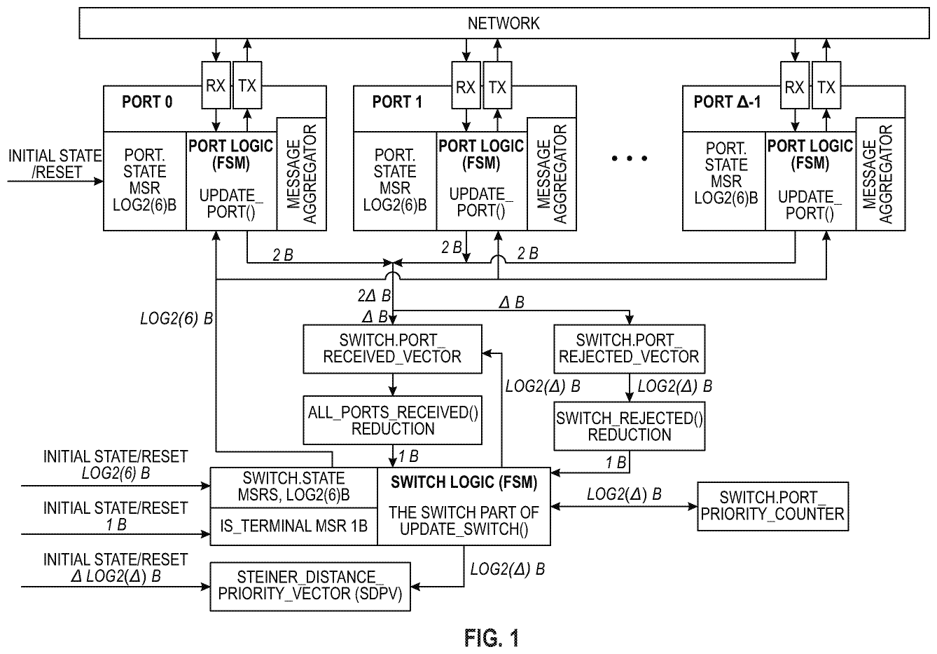

FIG. 1 depicts an overview of switch logic to implement a gossip protocol. In this example, the switch finite state machine (FSM) operates on each update cycle, reading the local model specific registers (MSRs) or other control registers to obtain the current state: switch.state, is_terminal, and steiner_distance_priority_vector. The switch FSM also reads local memory buffers with values switch.port_received_vector, switch.port_rejected_vector, and switch.port_priority_counter, and conditionally modifies steiner_distance_priority_vector and switch.port_priority_counter.

Port FSMs operate independently of the switch FSM and of each other. Conditionally, port FSMs update their corresponding bits in switch.port_received_vector and switch.port_rejected_vector of the switch agent.

The Switch FSM broadcasts the current state to the Port FSMs. This broadcast can be done sparsely when the state changes. The overall complexity grows with the number of ports (Δ), with the complexity growth (OΔ)=Δ log₂(Δ), primarily due to an increase in SDPV size.

The signaling complexity between the switch and port agents grows linearly with the number of ports. The mechanism must be replicated if multiple terminal sets require configuration, which is a likely case when building multiple aggregation trees.

This arrangement uses two classes of FSMs, implemented at the switch level (the Switch FSM) and at the port level (the Port FSM), to execute the gossip protocol and advertise, between all nodes of the network, the relative distances between nearest terminals of the network visible from the local port's perspective. The distances are encoded as SDPVs in each network switch. An SDPV is a vector of priorities, where the highest priority is assigned to the port that is assumed to point in the direction of the closest terminal, and the lowest priority is assigned to the port in the direction furthest from the nearest terminal.

The gossip protocol is assumed to be initiated in all terminal switches of the network. In an example, all terminal switches send broadcast messages (GossipMessageStatesEnum.BROADCAST_REQUEST) simultaneously on all ports. As the messages arrive in other switches, the order of arrival is encoded in the SDPV. Upon the first message arrival, a non-terminal switch enters broadcasting mode and sends broadcast messages on all ports except the highest-priority (first-arrived) port. The broadcast propagates through the network until all active ports on all switches receive it. Once all switches enter SwitchStatesEnum.CONFIGURED state, the gossip protocol has finished, and all SDPVs of all switches contain the correct priority order.

By simultaneous broadcasting, a race is created in the network. For unoccupied networks, this race will effectively measure the latency ordering of the shortest paths to nearest terminals, specifically by measuring the ordering of latencies visible on different ports; for networks with background traffic, the effective latency ordering will be measured. This allows for both static and dynamic mapping of aggregation trees under custom load conditions.

Broadcasting may create a loopback cycle between one port of the switch and another port on the same switch. For simplicity, these cycles are allowed, since the gossip protocol is only a local heuristic, and there is no need to track whether the paths lead exclusively to other terminals. Since switches only broadcast once, there is no risk of oscillations, and there is no need for message lifetime tracking. Furthermore, because loopbacks have to be shorter than the actual inter-terminal distances to be detected by the switch, the distances between any node of the loopback and the terminals should not be dominated by the loopback length. The loopbacks will also be pruned by the aggregation tree autoconfiguration protocol if they are detected as non-terminal branches. No visible performance effects are expected to occur from loopbacks.

As noted above, the logic diagram for an in-switch implementation of a Steiner-priority gossip protocol-based collective communication autoconfiguration is presented in FIG. 1. An update procedure applies the update to all FSMs on the switch concurrently, with a synchronous exchange of information between them.

The logic of an update cycle of a Switch FSM for this approach is presented in the pseudocode of TABLE 4 below. The Switch FSM tracks the ports on which messages were received and sent and conditionally updates the SDPV with the port priorities. The switch state must be communicated to FSMs at every cycle. Because the switch state can only change in response to new messages arriving, this communication can be event-based, with the new state broadcast on state transition.

The logic of an update cycle of a Port FSM is presented in the pseudocode of TABLE 5 below. The Port FSMs make decisions about whether to reply to messages and communicate with the Switch FSM sparsely by setting their corresponding bits in switch.port_received_vector and switch.port_rejected_vector bitvectors maintained in a register.

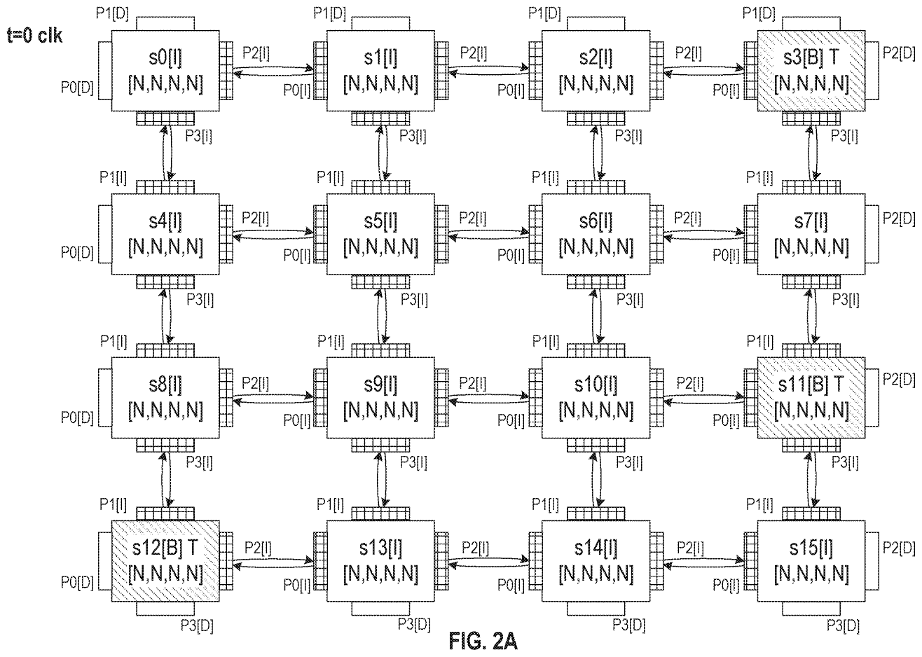

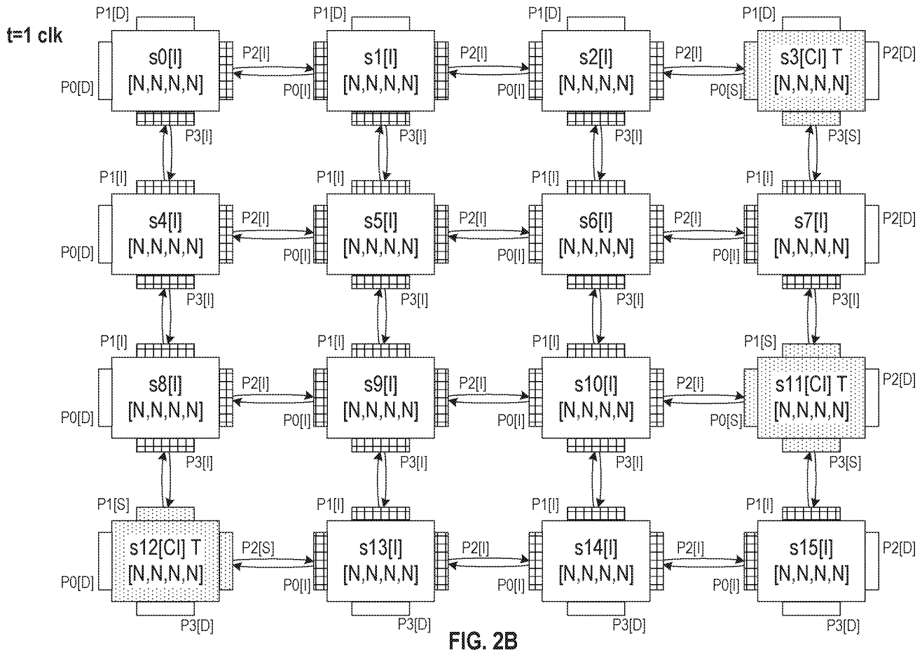

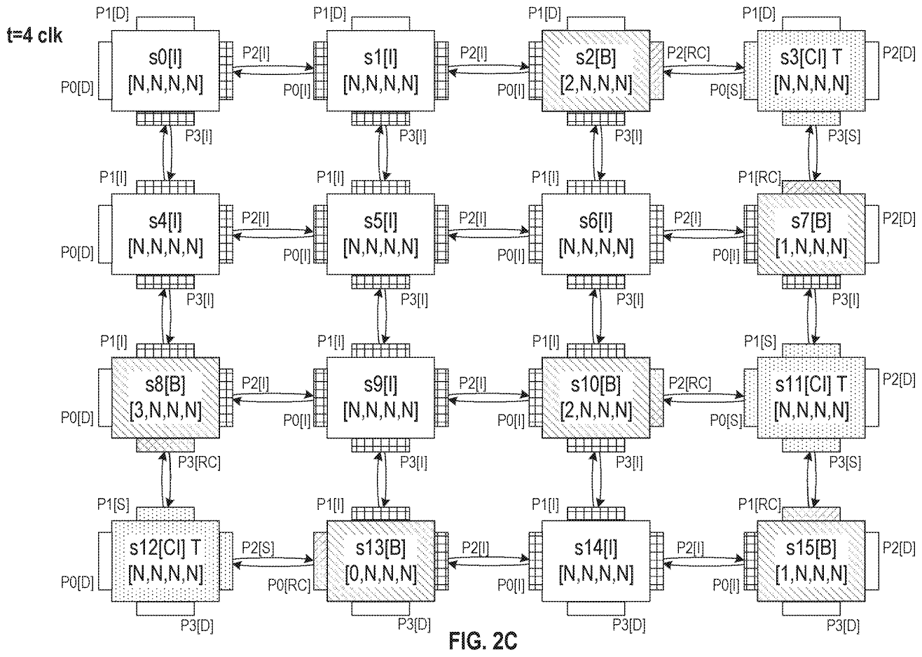

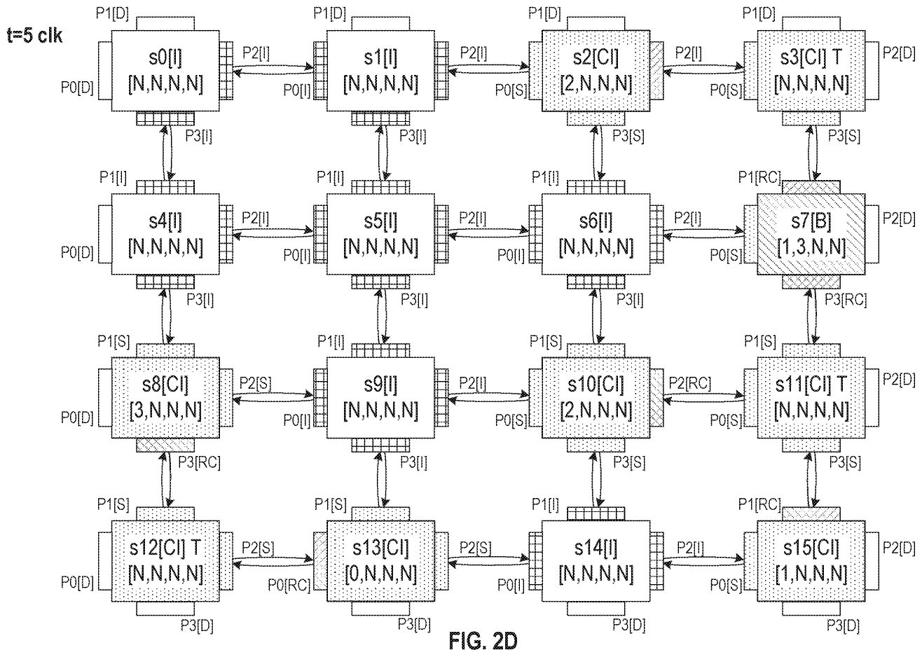

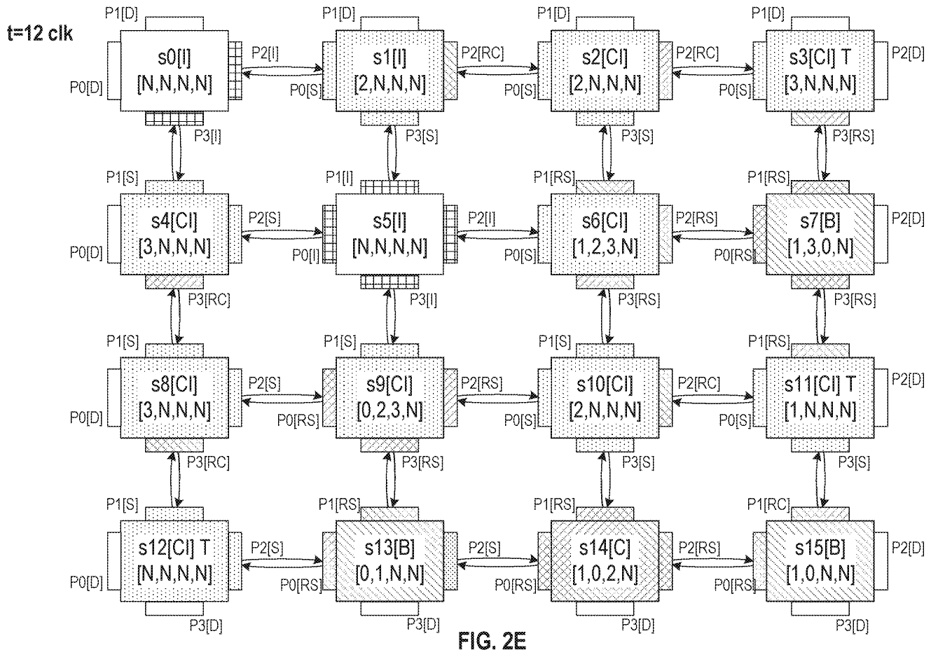

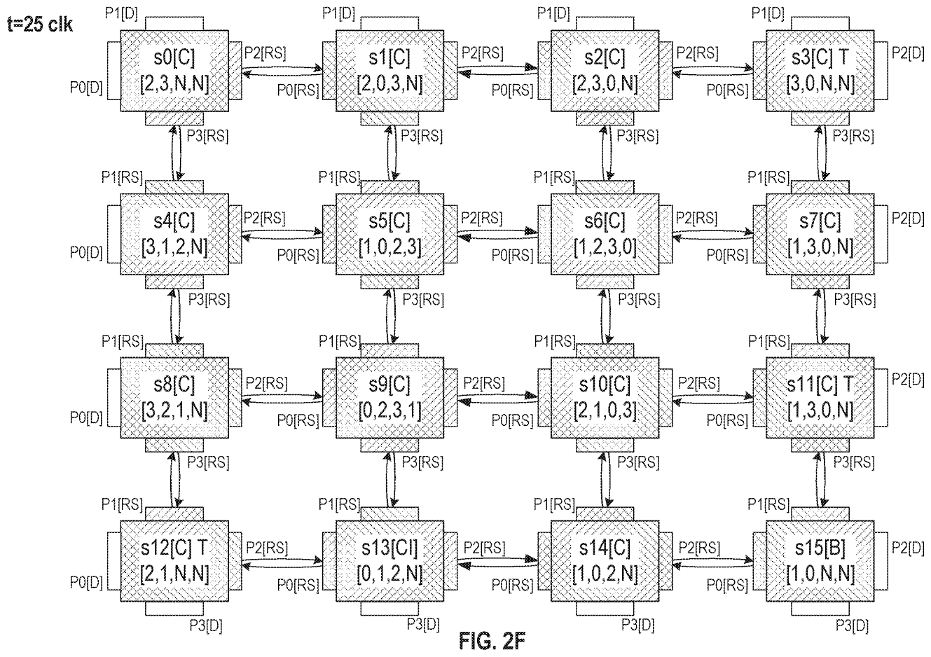

FIGS. 2A to 2F present an example of state evolution for a 16-node (4×4) Mesh2D topology with 20% random terminals, implementing the present techniques for collective communication autoconfiguration with a gossip protocol. The network in this example may include non-uniform link latencies, reflecting the increased physical distance between switches in a real-world scenario. The variability causes races between the fastest paths to the nearest terminal, visible at a given port. Switches construct the SDPV greedily, guaranteeing optimal priorities for deterministic latencies.

FIG. 2A depicts a scenario at t=0 where a set of Terminal switches (T) are set into the INITIATE_AUTOCONFIGURATION (A) state, which immediately transitions into the BROADCASTING (B) state. In the depicted example of FIG. 2A, switches s3, s11, and s12 are marked as terminals.

FIG. 2B depicts a scenario at t=1 where BROADCASTING (B) switches send a single BROADCAST_REQUEST (BR) message on all active ports, and enter the CONFIGURING (CI) state, awaiting BR messages to be received on all active ports. DISABLED (D) ports are ignored. The sending ports switch their state to SENT(S) to avoid future sends on the same ports. In the depicted example of FIG. 2B, switches s3, s11, and s12 send request messages on ports s3:P0, s3:P3, s11:P0, s11:P1, s11:P2, s12:P1, and s12:P2, and ports s3:p1, s3:p2, s11:p2, s12:p0, and s12:p3 are ignored.

FIG. 2C depicts a scenario at t=4 where once the BROADCAST_REQUEST messages arrive at peer switches, the switches transition to the BROADCASTING (B) state and set the first entry in their SDPV to the local port corresponding to the closest terminal. The receiving port transitions into a RECEIVED (RC) state. In the depicted example of FIG. 2C, switch s8 received a message from s12:P1 on port s8:P3. The first entry of SDPV is now marked with that port ID; the remaining are undefined ([3, N, N, N]).

FIG. 2D depicts a scenario at t=5 where, in the next cycle, the B switches transition to the CONFIGURING (CI) state and send BR messages on all active ports, except for the first port annotated in SDPV. If the switch receives two messages on different ports, only the first request triggers broadcasting. If a port has already sent a message and received a message, it enters the RECEIVED SENT (RS) state. In the depicted example of FIG. 2D, the s7 switch retained the B state because two request messages were received first on ports s7:P1 and later on s7:P3. Port s7:P3 transitions into the RECEIVED_SENT (RS) state, denoting that this port has both sent and received broadcast messages. Port s7:P1 retains the RECEIVED state since the switch did not receive a request coming from another direction.

FIG. 2E depicts a scenario at t=12 showing where, if a switch receives messages on all ports, it enters the final CONFIGURED (C) state. As a caveat, an additional situation may arise for networks with branches that do not connect to any terminals. If a non-terminal switch with one active port receives a B message, it replies to the only active port with RESPONSE_NO_TERMINALS (RN) message. A port that receives RN message, enters the R state. R-state ports are accounted as configured (like RS) when transitioning the switch to C. Non-terminal subnetworks may still propagate the broadcast back to the subnetwork root (a cycle), but these do not play a significant role in terminal connection patterns and will likely be pruned by derived algorithms.

In the depicted example of FIG. 2E, switch s14 received request messages on enabled ports s14:P0, s14:P1, and s14:P2. Because the messages came from at least two directions, all ports are in RECEIVED SENT state, and the switch is considered configured. Notably, there are no non-terminal subnetworks in this example. Such a network can be easily constructed by connecting any network with no terminals to a single link. This is an important corner case that supports a variety of non-canonical scenarios involving network topology and terminal selection, and makes the algorithm resilient to link failures.

FIG. 2F depicts a scenario at t=25 showing that messages continue to propagate across the network until all switches enter the C state. In the depicted example shown in FIG. 2F, all switches sent and received messages on all ports and entered the CONFIGURED state. Terminals can be inspected to unlock control flow at software or higher-level protocol levels.

TABLE 1 provides a definition of states for a per-port finite state machine (FSM) used in the preceding examples as follows:

TABLE 1

| Port State | |
|---|---|
| [GossipPortStatesEnum] | Description |
| DISABLED (D) | The port is disabled and will not be used for sending or receiving |
| | gossip messages. |
| IDLE (I) | The port is IDLE. The port will enter the RECEIVED state if a |
| | BROADCAST_REQUEST message is received. The port will |
| | enter the REJECTED state if RESPONSE_NO_TERMINAL is |
| | received. |
| REJECTED (R) | The port is rejected. The network branch to which this port is |
| | connected does not contain any terminals. This is a final state. |
| RECEIVED (RC) | The port received a BROADCAST_REQUEST message but did |
| | not send a message. |
| RECEIVED_SENT (RS) | Both ports received a BROADCAST_REQUEST message and |
| | responded. This is a final state. |
| SENT (S) | The port sent a message. |

TABLE 2 provides a definition of per-switch finite state machine (FSM) states used in the preceding examples as follows:

TABLE 2

| Switch State | |
|---|---|
| [GossipSwitchStatesEnum] | Description |
| IDLE (I) | The switch is idle and awaiting a |
| | BROADCAST_REQUEST message. |
| INITIATE_AUTOCONFIGURATION (A) | (Transient state) The autoconfiguration is initiated by an |
| | external agent setting this state on every terminal switch, or |
| | by an IDLE switch receiving the first |
| | BROADCAST_REQUEST message. The terminal |
| | transitions immediately into the BROADCASTING state. |
| BROADCASTING (B) | (Transient state) When the switch enters |
| | BROADCASTING state, all enabled ports send a |
| | BROADCAST_REQUEST message. The switch |
| | transitions immediately into the CONFIGURING state. |
| CONFIGURING (CI) | The switch remains in this state until all ports receive the |
| | gossip protocol messages. A non-terminal switch |
| | transitions to a CONFIGURED state if at least two ports |
| | received BROADCAST_REQUEST messages or if the |
| | switch is a terminal switch. A switch enters the |
| | REJECTING state if it is non-terminal, all ports have |
| | received messages, and at most one port has received a |
| | BROADCAST_REQUEST message. |
| REJECTING (R) | (Transient state) The switch sends a |
| | RESPONSE_NO_TERMINAL message to all |
| | CONFIGURED ports. The switch transitions immediately |
| | into the CONFIGURED state. |
| CONFIGURED (C) | Terminal state. A switch enters this state once all enabled |
| | ports have received the gossip protocol messages. |

TABLE 3 provides a list of the message types exchanged between switches during the gossip protocol execution. The gossip protocol requires two states (1b) per message.

TABLE 3

| Message States | |
|---|---|
| [GossipMessageStatesEnum] | Description |
| BROADCAST_REQUEST | The |
| | GossipMessageStatesEnum.BROADCAST_REQUEST |
| | message is sent by a switch that is either a terminal, at the |
| | beginning of the autoconfiguration process, or any non- |
| | terminal switch once the first |
| | GossipMessageStatesEnum.BROADCAST_REQUEST |
| | message is received on any port. The order of arrival of |
| | the messages is important in determining the SDPV |
| | priorities - the ports that receive earlier are expected to be |
| | closer to any terminal and will receive a higher priority. |
| RESPONSE_NO_TERMINAL | If an isolated non-terminal switch receives the |
| | GossipMessageStates.BROADCAST_REQUEST, the |
| | only port available becomes marked as RECEIVED. |
| | Since no broadcast was received on any other port, it |
| | cannot send a request on the receiving port. Instead, it |
| | responds with |
| | GossipMessageStates.RESPONSE_NO_TERMINAL |
| | to mark that this branch of the network is non-terminal |
| | and should be excluded from prioritization. |
| | In a chain of isolated non-terminal switches, the broadcast |
| | phase is executed in all switches except the last one. The |
| | last switch responds with |
| | GossipMessageStates.RESPONSE_NO_TERMINAL. |
| | Because all nodes in the chain can now unambiguously |
| | identify the branch as non-terminal, they will forward the |
| | same message on the original receiving port. |
| | A corner-case scenario is possible in which a loop with no |
| | terminal switch can form in the isolated sub-network. |
| | Since the gossip protocol allows loops for simplicity, this |
| | should have no impact on subsequent autoconfiguration |
| | and the non-terminal subnetwork will be pruned. |

Example pseudocode for implementing this approach in a per-switch FSM is provided as follows in TABLE 4:

```
TABLE 4
def update_switch(switch):
  # Per-port reduction signals.
  # Select only one of the ports that received a BROADCAST message
  # This assumes HW takes care of proper synchronization of bcast_req_port_id
  # before the dependent logic progresses.
  switch.active_port = −1
  for i in range(switch.num_ports):
    enabled = switch.ports[i].state != GossipPortStatesEnum.DISABLED
    active = switch.port_received_vector[i]
    if enabled and active:
      switch.set_state(SwitchStatesEnum.INITIATE_AUTOCONFIGURATION)
      # A new port was configured.
      # Set the priority and mark as configured.
      switch.steiner_distance_priority_vector[switch.port_priority_counter]=i
      switch.port_priority_counter += 1
      # Reset the activation signal to avoid double accounting.
      switch.port_received_vector[i] = 0
      # Only one activation can be processed per cycle.
      # Break here and continue with priorities at next iteration.
      switch.active_port = i
      break
  # Switch logic
  if switch.state == SwitchStatesEnum.INITIATE_AUTOCONFIGURATION:
    # This is a transient state.
    switch.set_state(SwitchStatesEnum.BROADCASTING)
  elif switch.state == SwitchStatesEnum.BROADCASTING:
    # This is a transient state.
    switch.set_state(SwitchStatesEnum.CONFIGURING)
    elif switch.state == SwitchStatesEnum.CONFIGURING:
      if switch.switch_rejected( ):
        switch.set_state(SwitchStatesEnum.REJECTING)
      elif switch.all_ports_received( ):
        switch.set_state(SwitchStatesEnum.CONFIGURED)
    elif switch.state == SwitchStatesEnum.REJECTING:
      # This is a transient state.
      switch.set_state(SwitchStatesEnum.CONFIGURED)
    elif switch.state == SwitchStatesEnum.IDLE:
      # All ports configured. The switch should enter the configured state and block
      # further requests.
      if switch.port_priority_counter == switch.enabled_ports_counter:
        switch.set_state(SwitchStatesEnum.CONFIGURED)
    else:
      # For other states, do nothing.
      pass
  def all_ports_received(switch):
    return switch.port_priority_counter == switch.enabled_ports_counter
  def switch_rejected(switch):
    is_nonterminal = not switch.is_terminal
    no_terminal_designation =
      sum(switch.port_rejected_vector) == (switch.enabled_ports_counter - 1)
    return is_nonterminal and no_terminal_designation
```

Example pseudocode for implementing this approach in a per-port FSM is provided as follows in TABLE 5:

```
TABLE 5
  def update_port(port, switch):
    # In a single cycle send and receive
    # at most one message in each direction.
    if switch.state == SwitchStatesEnum.BROADCASTING:
      # Do not send a broadcast on disabled and recently receiving
      # ports. Avoid sending messages if the port
      # already sent a message.
      if port.state not in
[GossipPortStatesEnum.DISABLED,GossipPortStatesEnum.REJECTED,
          GossipPortStatesEnum.RECEIVED_SENT, GossipPortStatesEnum.SENT] \
          and switch.active_port != port.local_port_id:
        port.send_message({‘state’: GossipMessageStatesEnum.BROADCAST_REQUEST})
        if port.state == GossipPortStatesEnum.RECEIVED:
            port.set_state(GossipPortStatesEnum.RECEIVED_SENT)
        else:
            port.set_state(GossipPortStatesEnum.SENT)
    elif switch.state == SwitchStatesEnum.REJECTING:
      if port.state == GossipPortStatesEnum.RECEIVED:
        port.send_message({‘state’:
GossipMessageStatesEnum.RESPONSE_NO_TERMINALS})
        port.set_state(GossipPortStatesEnum.RECEIVED_SENT)
    if port.state in [GossipPortStatesEnum.DISABLED, GossipPortStatesEnum.REJECTED,
                GossipPortStatesEnum.RECEIVED_SENT]:
      pass # Do nothing
    elif port.state in [GossipPortStatesEnum.IDLE, GossipPortStatesEnum.SENT]:
      if port.has_incoming_message( ):
        msg = port.receive_message( )
        msg_state = msg.payload[‘state’]
        # Signal switch that the port received
        # a configuration message.
        switch.port_received_vector[port.local_port_id] = 1
        if msg_state == GossipMessageStatesEnum.BROADCAST_REQUEST:
            if port.state == GossipPortStatesEnum.SENT:
              port.state = GossipPortStatesEnum.RECEIVED_SENT
            else:
              port.state = GossipPortStatesEnum.RECEIVED
        elif msg_state == GossipMessageStatesEnum.RESPONSE_NO_TERMINALS:
            switch.port_rejected_vector[port.local_port_id] = 1
            port.state = GossipPortStatesEnum.REJECTED
    elif port.state == GossipPortStatesEnum.RECEIVED:
      if port.has_incoming_message( ):
        msg = port.receive_message( )
        msg_state = msg.payload[‘state’]
        assert msg_state == GossipMessageStatesEnum.RESPONSE_NO_TERMINALS,
            ‘The port already received BCAST’
        switch.port_rejected_vector[port.local_port_id] = 1
        port.state = GossipPortStatesEnum.REJECTED
    else:
      assert False, ‘Invalid Port state’
```

Among other benefits, the use of this gossip protocol enables disaggregated autoconfiguration protocols to make heuristic decisions about port priority selection, by estimating the order of closest terminals in the network. The mechanism works in a disaggregated manner using a multi-source network broadcasting to maximize concurrency. It is scalable and limited by the network diameter.

The gossip protocol is hardware-implementable and can be integrated into network switches, including those used with various network-on-chip implementations. The gossip protocol is low-overhead in terms of execution time and does not require complex software to manage and synchronize the exchange of information between switches. It also eliminates the need for complex, offline-calculated priority vectors through explicit network modeling. The mechanism applies to both heterogeneous and homogeneous networks and is resilient to non-canonical network connections.

### Port-Priority Selection Mechanism for the Aggregation Tree Autoconfiguration

The following provides a Port Prioritizer to select the next port to explore when constructing collective communication-embedded aggregation trees. This technique can be used in combination with the in-switch autoconfiguration mechanism discussed herein to select ports sequentially to explore the network in search of terminal nodes.

On the descending path, a priority must be applied to select paths that are closer to terminals and lie on the least congested paths. The first objective aims at the reduction of the span of the aggregation trees and to avoid adding non-terminal (forwarding) switches to the aggregation. The second objective aims at increasing the bandwidth of collective operations, such as allreduce, by maximizing the use of independent network pathways.

The following port-priority selection mechanism provides a low-overhead approach applicable for in-switch, hardware-based aggregation tree construction, including in the context of Network-on-Chip (NoC) applications. As will be understood, the following selection mechanism is designed in a modular fashion. It defines priority selection as a function of the switch's current state and may operate independently from the SDPV vector calculations (discussed above) and autoconfiguration protocol behavior (discussed below).

The following selection mechanism thus provides a basic heuristic used for port selection. Other aspects of port scoring can be based on the occupancy and static priority values like SDPV, such as discussed above. However, specializations of the port selection can be done based on topology classes, e.g., favoring local vs. remote links.

In an example, for each port, a scoring value is calculated according to the formulas:

$$occupancy [ pid ] = {\sum }_{i = 0}^{K - 1} is\_occupied ( pid , vc = i ) \qquad FORMULA 1$$

$$score [ pid ] = Δ * occupancy [ pid ] + SDPV [ pid ]$$

For each port (pid), the occupancy is calculated as the number of aggregation trees (or Virtual Channels (VCs)) assigned to the port. A VC is occupied if the per-port Finite State Machine (FSM) is in either ROOT_PORT or DESIGNATED_PORT states, denoting the ascending and the descending directions in the aggregation tree, respectively. By multiplying by the number of ports Δ, a round-robin order is applied in port selection. This order forces the bypass paths to be prioritized. If two ports have the same occupancy, the final score is determined by SDPV: ports closer to the next terminal are favored.

It is important to note that the port scoring does not guarantee that a port will be selected by the autoconfiguration protocol. Rather, port scoring only determines the order of network exploration.

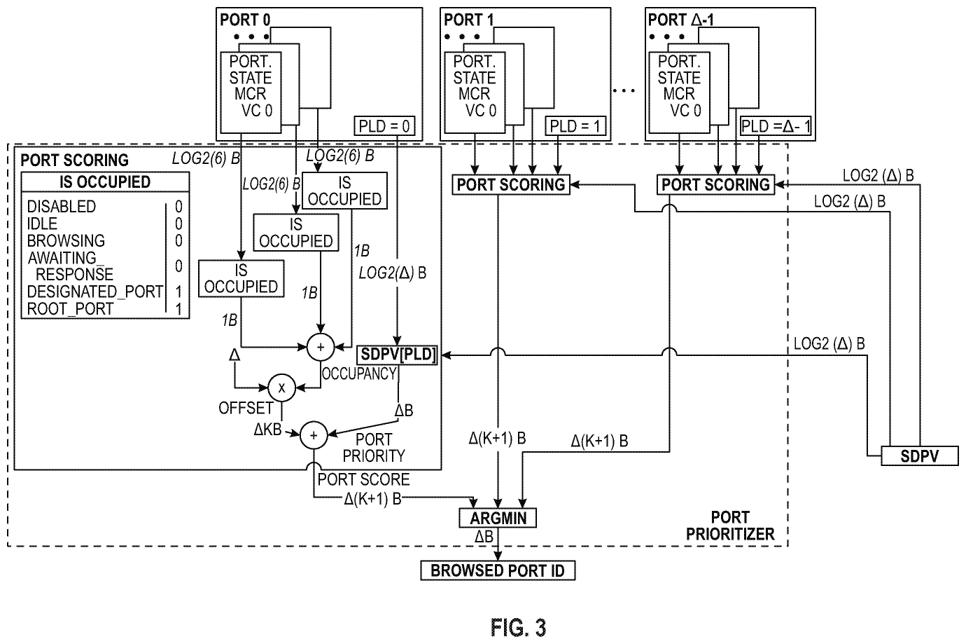

FIG. 3 depicts an overview of an implementation of port scoring logic. In this implementation, the Port Prioritizer block calculates individual scores for each port. The score is a function of current occupancy, the number of aggregation trees already assigned to the port, and the precomputed Steiner Distance Priority Vector (SDPV). The port with the minimum score is selected as the next candidate for aggregation tree construction.

Pseudocode for the scoring mechanism implementation is provided as follows in TABLE 6. The logic of select_next_browsed_port_id( ) is assumed to happen within one switch update cycle.

```
TABLE 6
def select_next_browsed_port_id(switch, vc):
  num_vc = switch.num_virtual_channels
  browsed_port_id = None
  browsed_port_score = None
  for port_id in range(len(switch.ports)):
    port = switch.ports[port_id]
    # Offset the score with SDPV value - ports with the same occupancy
    # should be selected based on SDPV priorities.
    port_score = switch.steiner_distance_priority_vector[port_id]
    # Count the occupancy as the number of VCs already configured for
    # transfers on this port.
    for vc_state in port.state:
      if vc_state in [PortStatesEnum.ROOT_PORT, PortStatesEnum.DESIGNATED_PORT]:
        port_score += len(switch.ports)
    # Scoring is only applied if the port is IDLE.
    # The port with the lowest score is selected as the next candidate.
    if port.state[vc] == PortStatesEnum.IDLE and \
        (browsed_port_id is None or browsed_port_score > port_score):
      browsed_port_id = port_id
      browsed_port_score = port_score
  return browsed port_id
```

When requested, the priority selector calculates a priority score for each port and selects the port with the lowest score value. The score is calculated by offsetting the SDPV priorities with the product of switch degree and the current occupancy, the number of virtual channels assigned to the port. Because of the symmetry of allreduce data transfers in both ascending and descending directions, both ROOT_PORT and DESIGNATED PORT configurations are treated equally.

While the formulas listed above assume summation and multiplication, other approaches may be used. For a small number of virtual channels, the occupancy can be computed using a lookup table or a small combinatorial circuit. The multiplication by A can be replaced by a logical shift for a power-of-two switch radix. Additionally, although SDPV can be treated as a vector, the SDPV vector entries may be distributed across port agents' MSRs to improve locality, because ports depend on their private SDPV [pid] entries.

### Aggregation Multi-Tree Embedding Autoconfiguration Protocol for in-Network Collectives

The following provides approaches for negotiating an aggregation tree structure in a network of switches, including constructing a Steiner Arborescence (directed tree) connecting selected terminal nodes. The following includes an autoconfiguration protocol implemented at the hardware switch level that allows embedding multiple collective communication aggregation trees to limit contention. The aggregation trees are built using a priority-DFS approach, with priorities determined by an external priority-selection mechanism. In an example, the autoconfiguration protocol uses two types of FSMs with accompanying logic, as discussed above: FSMs at the port level and FSMs at the switch level.

The final states of the FSM determine the directions of communication on the aggregation tree. The order from the leaves to the root is determined by exactly one of the port FSMs of a switch configured with the ROOT PORT state. This direction follows a reduction order of a barrier or an allreduce operation. The descending order is determined by port FSMs configured in the DESIGNATED PORT state. The descending direction corresponds to the broadcast phase of a barrier or an allreduce operation.

Since the autoconfiguration mechanism is dedicated to embedding multiple aggregation trees over the same physical network of switches, the logic must be replicated for each aggregation tree (or a Virtual Channel (VC)) independently. Both switch and port FSMs, as well as the logic signals, must be replicated for each VC to enable concurrent autoconfiguration.

The autoconfiguration protocol is designed so that port FSMs do not directly exchange information and interact minimally with switch FSMs. If possible, decisions about messaging are performed locally, at each port. A switch FSM requires information about the overall status of all ports, which can be obtained by straightforward reductions.

The implementation of this autoconfiguration protocol may provide a variety of technical benefits. The switches can be configured in a distributed fashion, without interactions with external agents. In peer-to-peer/nearest-neighbor communication patterns, any message is propagated within a one-hop distance. This improves both time and energy efficiency vs. alternative approaches. The autoconfiguration protocol can be triggered via software or hardware interaction, by a single-point (root switch) interaction. This creates an interface that is easy to manage and does not generate additional broadcast traffic on the network, thereby degrading the quality of discovered aggregation trees.

The autoconfiguration protocol can be provided for in-hardware implementation, for all network types in general, but specifically for NoC solutions where switch logic is a costly tradeoff with compute capabilities. The autoconfiguration protocol can be applied to any network class with a heterogeneous PHY interconnect, provided that each switch supports the protocol. The decision regarding the priority selection mechanism can be made separately for each switch class and does not affect the algorithm's stability. This allows the autoconfiguration protocol's heuristics to be adjusted for different scenarios without compromising the stability of the results, with minimal invasive modifications.

The autoconfiguration protocol can be trivially parallelized to configure all VCs simultaneously. The autoconfiguration protocol can be used for logical disaggregation on a shared physical fabric. Because of low reconfiguration cost, the reconfiguration is suitable for scenarios such as Virtual Machine migration or increased physical system load.

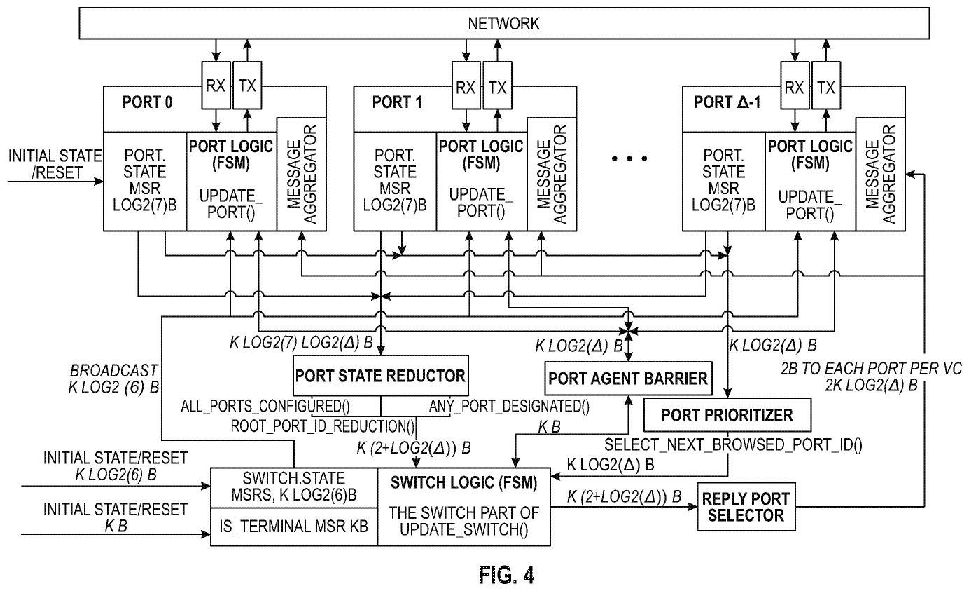

FIG. 4 depicts an overview of switch logic for implementing a port-priority selection mechanism for aggregation tree autoconfiguration. The switch FSM operates on each update cycle, reading the local MSRs containing the current state, switch.state, and is_terminal, as well as the reduced signals from port logic: all_ports_configured( ), root_port_id_reduction( ), and any_port_designated( ).

If needed, the switch FSM can request the port ID from PORT PRIORITIZER (select_next_browsed_port_id( )) (such as provided from the implementation discussed above with reference to FIG. 3). The majority of messaging is decided at the port logic. If necessary, the switch FSM can request additional messages via REPLY_PORT_SELECTOR. The logic follows independently for each of K Virtual Channels (VCs) and requires replication of messaging signals and state memory. The overall complexity grows linearly with the number of VCs and logarithmically with the number of ports (Δ).

Additional information about the order of browsing ports in the network is available from external heuristics (e.g., as implemented by the PORT PRIORITIZER block with reference to FIG. 3). While the priorities are decided dynamically, the autoconfiguration protocol does not require a priority decision at every update cycle. In specific situations, the switch FSM may require an additional message to be sent using one of the ports (REPLY PORT SELECTOR).

The specifics of how port priorities are determined for use by the aggregation tree autoconfiguration protocol may be implemented using the approaches discussed above. For example, the Steiner-priority gossip protocol that is described with reference to FIGS. 1 to 2F may be used to establish a Steiner Distance Priority Vector (SDPV), and the port-scoring logic described with reference to FIG. 3 may use the SDPV and port occupancy to select a next port for exploration. Although a port-priority selection mechanism can be implemented independently of the autoconfiguration protocol, combining the SDPV-based priority information with occupancy-based port scoring can improve the quality of the resulting aggregation trees by favoring paths toward terminal switches while reducing overlap with previously configured trees.

In an example, the aggregation tree autoconfiguration protocol starts with a selected root node and propagates through the network in a priority-based DFS. The priority-selection mechanism selects priorities for each switch individually based on a local Steiner Distance Priority Vector (SDPV) (e.g., a vector representing the shortest-path proximity to the nearest terminal switch) and the current occupancy of adjacent links (edge weights). The switches propagate the configuration messages recursively, exploring the network's IDLE branches according to the selected priorities. Once a branch is explored, the autoconfiguration protocol retracts through ROOT PORTS (RP), leaving switches in the CONFIGURED (C) state. A branch is pruned by setting switches in the REJECTED (R) state if the branch does not lead to any terminals. Once the confirmation is propagated to the VC's root, control is returned to the external agent (e.g., software or a higher-level protocol) and the next VC is configured.

Similar to the approaches above, the aggregation tree autoconfiguration protocol can include two classes of FSMs, implemented at the switch level (Switch FSM) and at the port level (Port FSM), to execute the aggregation tree autoconfiguration protocol at the network layer. The logic of an update cycle of a Switch FSM is presented in TABLE 7, below. The update procedure applies the update to each virtual channel (VC), where each VC represents a separate logical aggregation tree. The VCs can be updated independently at the same cycle for a hardware-parallel configuration. In an example, the FSM uses six states as described in TABLE 9, below. The SwitchStatesEnum.CONFIGURED and SwitchStatesEnum. REJECTED states are the final states of the FSM. The autoconfiguration protocol guarantees that all switches will reach the final state on all VC FSMs.

The logic of an update cycle of a Port FSM is presented in TABLE 8, below. The port FSM is separate for each supported virtual channel and, like the Switch FSM, can be updated for all VCs in parallel. There is no information exchange between VCs at the port level, and all VC Port FSMs operate by communicating with the peer port of another switch via messages or reduction signals to the switch FSM of the corresponding VC. In an example, each Port FSM uses seven states, as described in TABLE 10, below. PortStatesEnum.ROOT_PORT, PortStatesEnum.DESIGNATED_PORT, and PortStatesEnum.REJECTED are the terminal states of the Port FSM and are guaranteed to be reached by all enabled (e.g., not in the PortStatesEnum.DISABLED state) ports.

In an example, the autoconfiguration protocol uses three message states: MessageStatesEnum.REQUEST, MessageStatesEnum.RESPONSE_ACCEPT, and MessageStatesEnum.RESPONSE_REJECT, as described in TABLE 11, below. Because the messaging overhead is low, using only log 2 (3)=1.58 bits, this autoconfiguration protocol can be implemented either using a regular messaging mechanism with header encoding or dedicated signaling lines on the underlying physical medium.

Additional reduction signals can be used to implement the logic of Switch FSM transitions and are presented in TABLE 12, below. The logic can be implemented using asynchronous logic circuits as functions of Port FSMs, and it can be handled in parallel across all VCs. An additional reduction (select_next_browsed_port_id( )) can be used to select the port priority. In one variant, the priority mechanism decides based on the current occupancy, the number of VCs already assigned to the port, using the approach described in the Port-Priority Selection Mechanism discussion above.

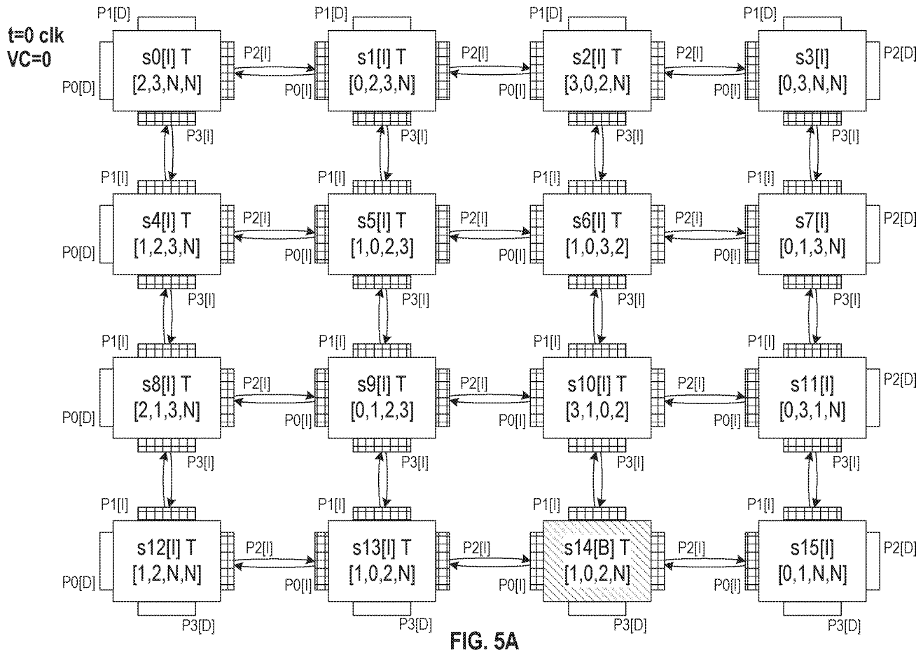

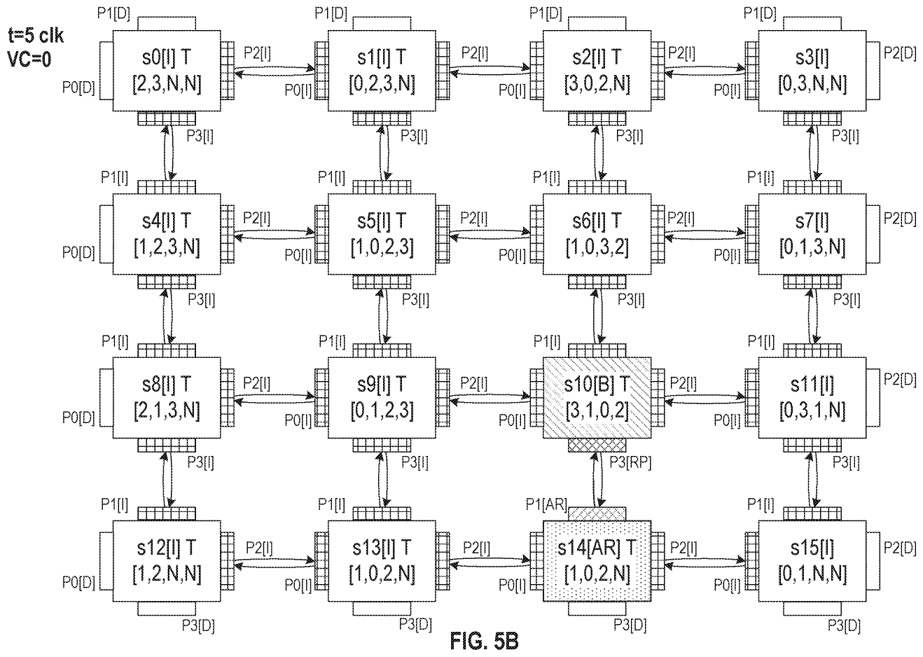

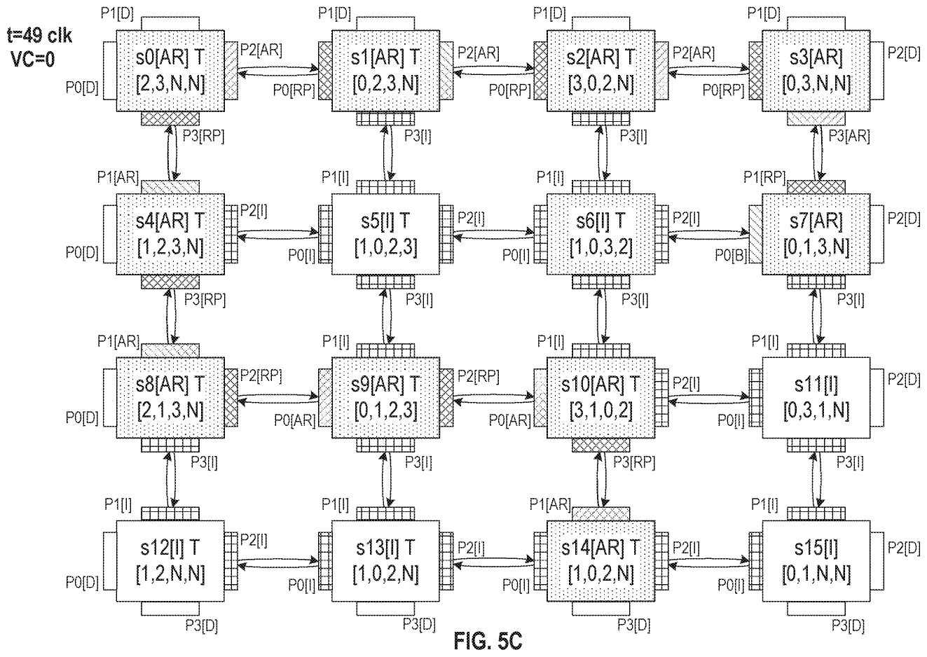

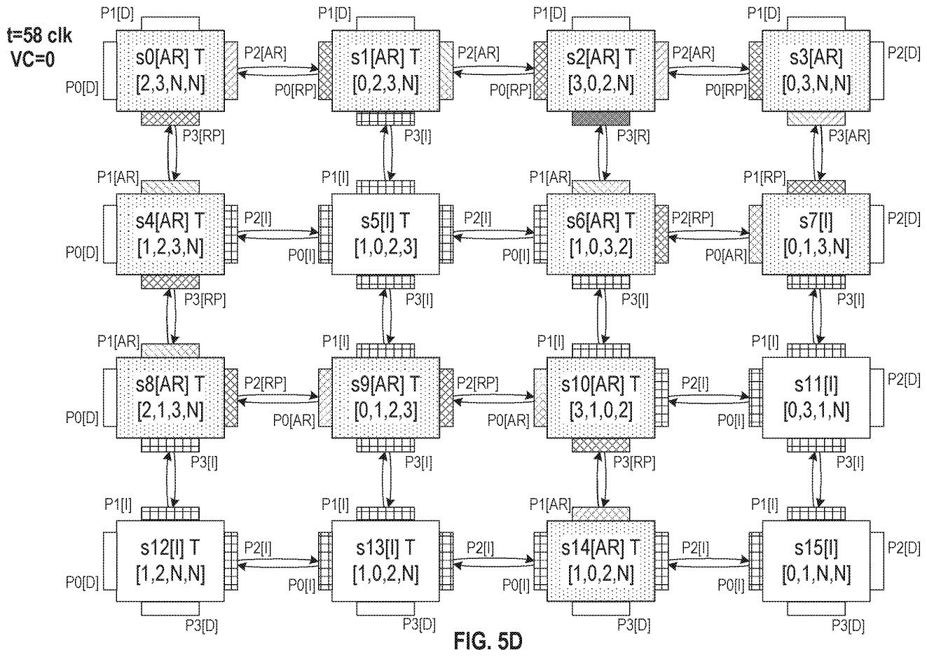

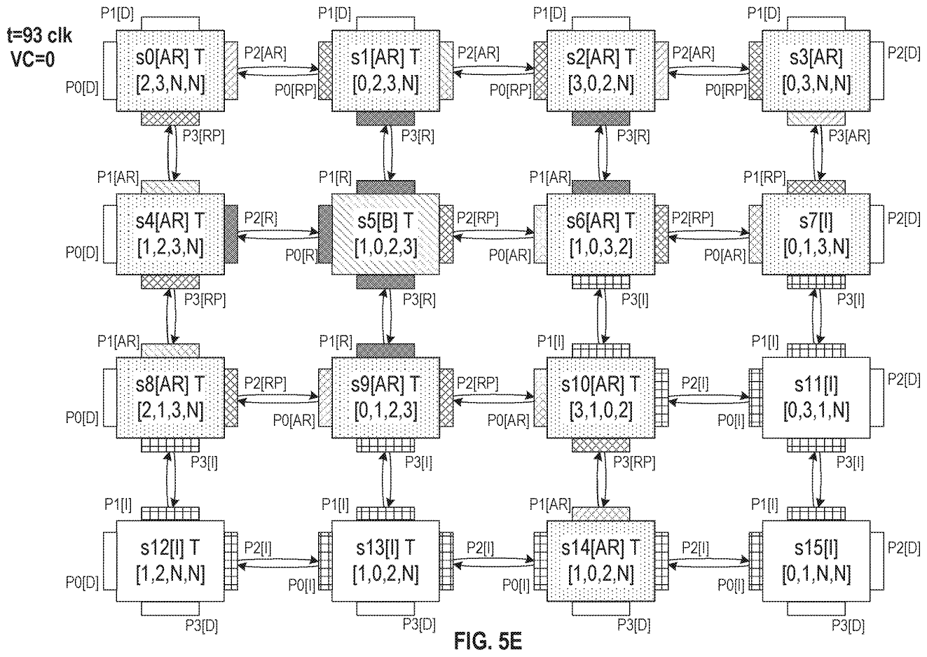

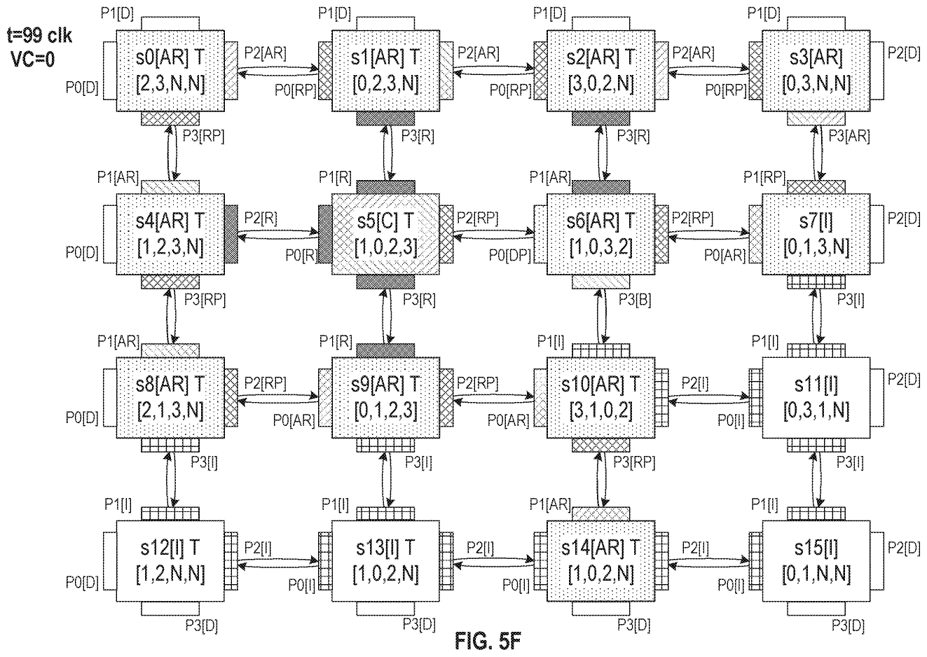

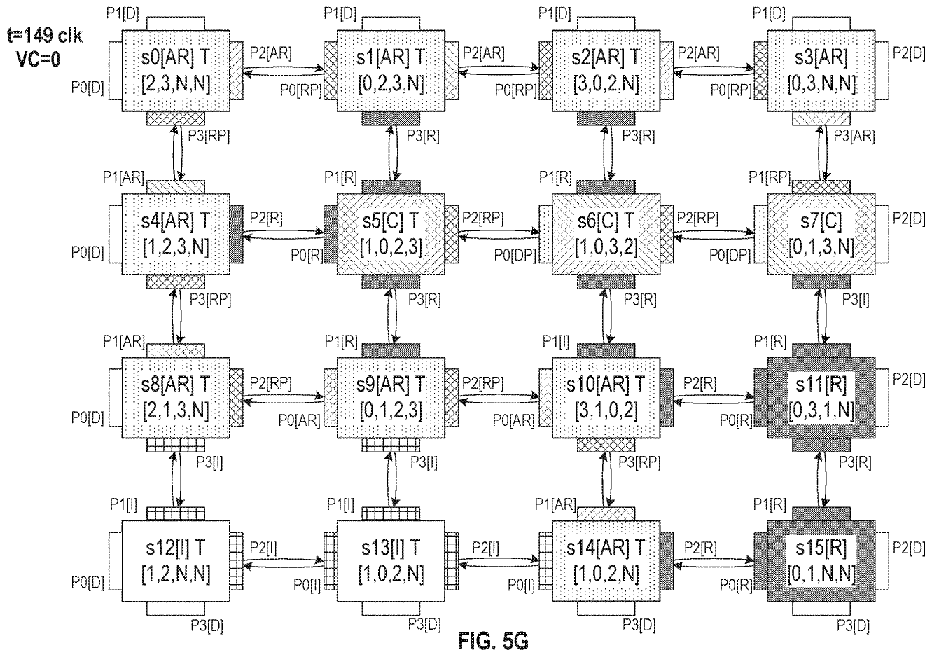

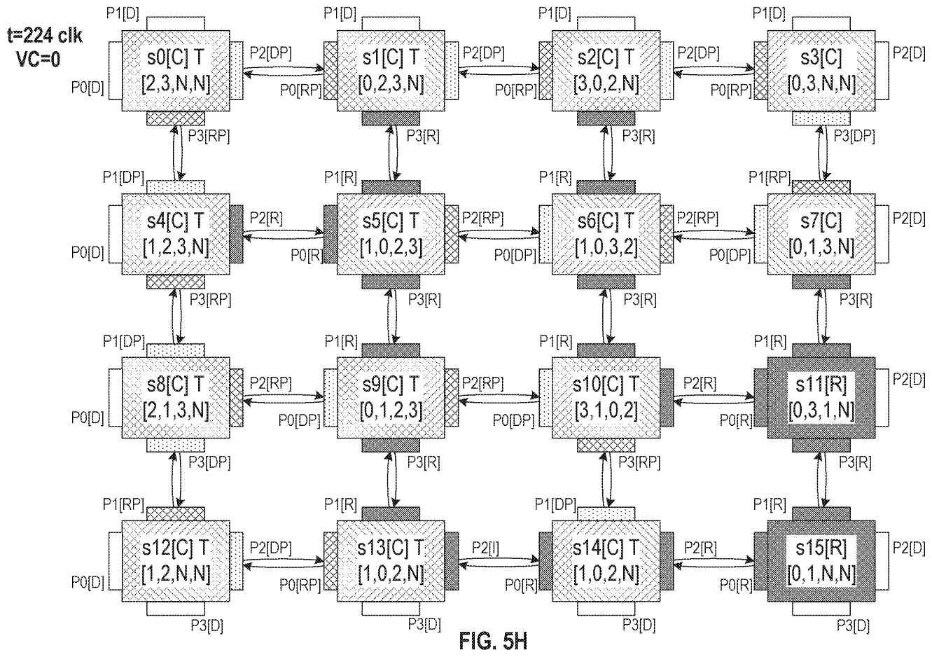

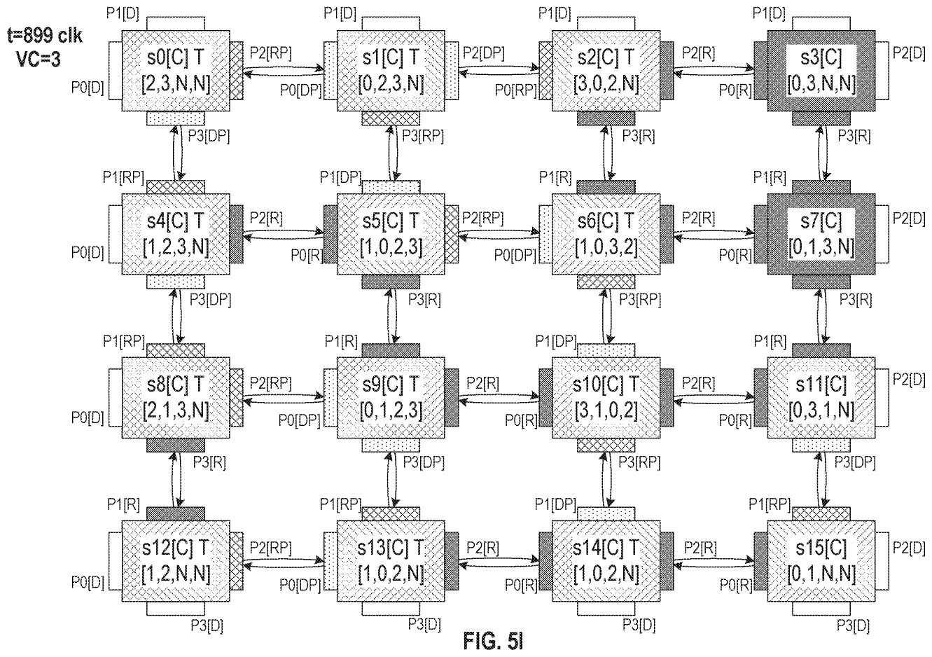

FIGS. 5A to 5I depict different stages of aggregation tree construction, according to one example. The depicted architecture is arranged similarly to the architecture depicted in FIGS. 2A to 2F, using a 16-node (4×4) Mesh2D topology with 20% random terminals.

FIG. 5A first shows that for each aggregation tree, or Virtual Channel (VC), at one of the switches of the network, designated as the root switch, the autoconfiguration protocol is initiated by an external entity, either software or a higher-level hardware protocol by setting the switch into SwitchStatesEnum.INITIATE_AUTOCONFIGURATION state. The state is transient, and the switch immediately enters SwitchStatesEnum.BROADCASTING state, starting the message propagation process on the descending path. In the example of FIG. 5A, switch s14 is selected as the root of the VC 0 aggregation tree.

FIG. 5B shows that the PortStatesEnum.DESIGNATED_PORTs point in descending direction. The direction represents the broadcast phase of an allreduce operation. In the depicted example, the switch s14 points in the descending direction with port P1. Additionally, in FIG. 5B, the PortStatesEnum.ROOT_PORTs point in the ascending direction. This direction represents the direction and order of an arithmetic reduction phase of an allreduce operation. In the depicted example, switch s10 points in the ascending direction with port P3.

FIG. 5C shows that on the descending path, from the root towards the terminals, of the autoconfiguration, the autoconfiguration protocol builds a spanning tree over the whole network. A SwitchStatesEnum.IDLE switch that receives an autoconfiguration MessageStatesEnum.REQUEST message marks the incoming port as PortStatesEnum.ROOT_PORT and starts sending MessageStatesEnum.REQUEST messages on other enabled ports, in order determined by a priority-selection mechanism. In the depicted example, switches s10, s9, s8, s4, s0, s1, s2, s3, s7 create a descending path, with s7 creating a first branch in the spanning tree.

FIG. 5D shows that if a switch is in a non-SwitchStatesEnum.IDLE state and a MessageStatesEnum.REQUEST message arrives, the port sends a MessageStatesEnum.RESPONSE_REJECT message. This property is critical to guarantee that no cycles are created in the aggregation tree. In the depicted example, switch s6 sent a request message on port P1. Switch s2 is already part of the spanning tree, and accordingly responded with rejection on port P3.

FIG. 5E shows that a switch continues network exploration in the descending direction until all enabled ports are either disabled or in a final state: PortStatesEnum.ROOT PORT, PortStatesEnum.DESIGNATED PORT, or PortStatesEnum.REJECTED. Once this condition is met, the switch sends a single MessageStatesEnum.RESPONSE_ACCEPT message on a PortStatesEnum.ROOT_PORT. In the depicted example, switch s5 is active, already received a request message on port P2, and sends request messages on ports P0, P1, and P3. All ports except for the root port (P2) received response messages. The switch responds on port P2 with the acceptance message, making it part of the aggregation tree (a terminal branch). The switch enters configured state in the next cycle.

FIG. 5F shows that on the ascending path, a receiving switch selects the next port, according to the priority selector mechanism, and sends a MessageStatesEnum.REQUEST message on the next port in the browsing order. In the depicted example, switch s6 received acceptance on port P0. It selects P3 as the next port and sends the next request to switch s9.

FIG. 5G shows that on the ascending path, if all ports are in a final state, and either the switch is terminal ([T]), or it has at least one PortStatesEnum.DESIGNATED_PORT, the switch represents a terminal branch of the aggregation tree. A terminal branch is a transitive property-any node on the path from a terminal branch to the root represents a terminal branch. In the depicted example, switches s5, s6, s7 (green) represent terminal branches. Additionally, on the ascending path, if all ports are in a final state and the switch is non-terminal and the branch is non-terminal, the switch responds with the PortStatesEnum.ROOT PORT with a MessageStatesEnum.RESPONSE_REJECT message, denoting that its branch should be pruned from the spanning tree. This uses network connections sparingly, thereby creating more opportunities for other VCs to branch. In the depicted example, switches s11 and s15 (red) represent non-terminal branches.

FIG. 5H shows that on the ascending path, if the root switch enters SwitchStatesEnum.CONFIGURED state, the autoconfiguration of the aggregation tree is complete. In the depicted example, the root switch s14 received messages on all ports and entered a configured state. Software or higher-level protocol can read the state and conclude the aggregation tree was identified on VC 0.

FIG. 5I shows that the autoconfiguration protocol can be executed for multiple VCs. Each VC may use the same or different set of terminals, and root, depending on the use-case. Each VC will configure a different aggregation tree. In the depicted example, VC 3 is the fourth VC configured with switch s11 selected as the root switch. The aggregation tree selected by the autoconfiguration protocol is different from VC 0, with a different selection of terminal/non-terminal branches.

TABLE 7 provides per-switch update logic pseudocode as follows:

```
TABLE 7
def update_switch(switch):
  for vc in range(switch.num_virtual_channels):
    state = switch.state[vc]
    if state == SwitchStatesEnum.INITIATE_AUTOCONFIGURATION:
        switch.set_state(SwitchStatesEnum.BROWSING, vc)
    elif state == SwitchStatesEnum.BROWSING:
      # Select next port for browsing
      if switch.all_ports_configured_reduction(vc):
        root_port_id = switch.root_port_id_reduction(vc)
        if root_port_id is not None:
          root_port = switch.ports[root_port_id]
          if switch.any_port_designated_reduction(vc) or switch.is_terminal[vc]:
                # Accept the root port if known that this is a forwarding
                # (has at least one designated port) or if this is a terminal node (terminal switch).
              root_port.send_message(MessageStatesEnum.RESPONSE_ACCEPT, vc)
              switch.set_state(SwitchStatesEnum.CONFIGURED, vc)
          else:
            root_port.send_message(MessageStatesEnum.RESPONSE_REJECT, vc)
            root_port.set_state(PortStatesEnum.REJECTED, vc)
            switch.set_state(SwitchStatesEnum.REJECTED, vc)
        else:
          switch.set_state(SwitchStatesEnum.CONFIGURED, vc)
      else:
        # Select the next unconfigured port and make it actively browsing.
        switch.browsed_port_id[vc] = switch.select_next_browsed_port_id(vc)
        switch.ports[switch.browsed_port_id[vc].set_state(PortStatesEnum.BROWSING, vc)
        switch.set_state(SwitchStatesEnum.AWAITING_RESPONSE, vc)
    elif state == SwitchStatesEnum.AWAITING_RESPONSE:
      if switch.port_designated_or_rejected[vc][switch.browsed_port_id[vc]]:
        switch.set_state(SwitchStatesEnum.BROWSING, vc)
    elif state == SwitchStatesEnum.IDLE:
      root_port_id = switch.root_port_id_reduction(vc)
      if root_port_id is not None:
        # IF any port is marked as a root port, then
              # the first message has already arrived.
        switch.set_state(SwitchStatesEnum.BROWSING, vc)
```

An IDLE switch that receives an autoconfiguration message automatically sets the receiving port as the root port and begins browsing remaining enabled ports. Once all ports are configured, the switch decides whether the tree branch it represents is a terminal branch. The non-terminal branches are pruned by sending a RESPONSE_REJECT message through the root port. Once the root switch has configured all ports, the virtual channel's autoconfiguration is complete.

TABLE 8 provides per-port update logic pseudocode as follows:

```
TABLE 8
def update_port(port, switch):
  # The protocol can handle multiple VCs configured simultaneously.
  # The decision whether the configuration is initiated on a single or
  # multiple VCs is left to the higher-level protocols.
  for vc in range(port.num_virtual_channels):
    state = port.state[vc]
    if state == PortStatesEnum.IDLE:
      if port.has_incoming_message(vc):
        msg = port.receive_message(vc)
        msg_state = msg.payload[‘state’]
        if msg_state == MessageStatesEnum.REQUEST:
          # Mark the port as the receiving port in the switch state.
          switch.request_received[vc][port.local_port_id] = 1
          if switch.state[vc] == SwitchStatesEnum.IDLE:
            # Mark the port as root port
            port.set_state(PortStatesEnum.ROOT_PORT, vc)
          else:
            port.send_message(MessageStatesEnum.RESPONSE_REJECT, vc)
            port.set_state(PortStatesEnum.REJECTED, vc)
    elif state == PortStatesEnum.BROWSING:
      port.send_message(MessageStatesEnum.REQUEST, vc)
      port.set_state(PortStatesEnum.AWAITING_RESPONSE, vc)
    elif state == PortStatesEnum.AWAITING_RESPONSE:
      if port.has_incoming_message(vc):
        msg = port.receive_message(vc)
        msg_state = msg.payload[‘state’]
        if msg_state == MessageStatesEnum.RESPONSE_ACCEPT:
          port.set_state(PortStatesEnum.DESIGNATED_PORT, vc)
          switch.set_port_designated_or_rejected(port.local_port_id, vc)
        elif msg_state == MessageStatesEnum.RESPONSE_REJECT:
          port.set_state(PortStatesEnum.REJECTED, vc)
          switch.set_port_designated_or_rejected(port.local_port_id, vc)
        elif msg_state == MessageStatesEnum.REQUEST:
          # If a broadcast arrived - send the rejection message. This also means that the peer
          # switch received a request from another path before.
          port.send_message({‘state’: MessageStatesEnum.RESPONSE_REJECT}, vc)
```

In this example, the port state is maintained independently for each VC, and all VCs are updated within the same update round. Each port sends and receives messages independently, based on its internal state and sparse (event-driven) access to the switch state.

TABLE 9 provides a definition of a per-switch finite-state machine (FSM). The autoconfiguration protocol uses six states (log 2 (6)=2.58 bits) per virtual channel, per switch.

TABLE 9

| Switch State [SwitchStatesEnum] | Description |
|---|---|
| IDLE [I] | The switch is SwitchStatesEnum.IDLE and awaiting a |
| | configuration MessageStatesEnum.REQUEST message. |
| INITIATE_AUTOCONFIGURATION [A] | The root switch is assigned by software or a higher-level |
| | protocol, which sets the switch to a |
| | SwitchStatesEnum.INITIATE_AUTOCONFIGURATION |
| | state. This is a transient state that transitions immediately |
| | to the SwitchStatesEnum.BROWSING state. |
| BROWSING [B] | The switch browses designated port candidates in the order |
| | defined by the priority selection mechanism. The switch |
| | enters SwitchStatesEnum.AWAITING RESPONSE if |
| | unconfigured ports are available. The switch enters the |
| | SwitchStatesEnum.CONFIGURED state once all enabled |
| | ports are marked as PortStatesEnum.ROOT_PORT, |
| | PortStatesEnum.DESIGNATED_PORT, or |
| | PortStatesEnum.REJECTED, and the tree branch is |
| | identified as terminal (at least one designated port or switch is |
| | terminal). If the switch has no designated ports and is not a |
| | terminal, the switch enters the |
| | PortStatesEnum.REJECTED state instead. |
| AWAITING_RESPONSE [AR] | The switch waits for the currently browsed port to receive a |
| | SwitchStatesMessage.RESPONSE_ACCEPT or |
| | SwitchStatesMessage.RESPONSE_REJECT message. |
| | Once received, it returns to the |
| | SwitchStatesEnum.BROWSING state. |
| CONFIGURED [C] | The final state. Once SwitchStatesEnum.CONFIGURED, |
| | the switch remains in this state until reset by software or a |
| | higher-level protocol. A |
| | SwitchStatesEnum.CONFIGURED switch always |
| | represents a terminal branch of the aggregation tree. |
| REJECTED [R] | The tree branch represented by this switch was identified as |
| | non-terminal, and the switch was |
| | SwitchStatesEnum.REJECTED from the aggregation tree. |

TABLE 10 provides a definition of a per-port finite-state machine (FSM). The autoconfiguration protocol uses seven states, (log 2 (7)=2.81 bits) per virtual channel, per port.

TABLE 10

| Port State [PortStatesEnum] | Description |
|---|---|
| DISABLED [D] | The port is disabled and will not be used for sending or receiving |
| | autoconfiguration messages. |
| IDLE [I] | The port is PortStatesEnum.IDLE. Upon receiving |
| | MessageStatesEnum.REQUEST message, the port will enter |
| | PortStatesEnum.ROOT_PORT state if switch is |
| | SwitchStatesEnum.IDLE or SwitchStatesEnum.REJECTED |
| | state otherwise. |
| BROWSING [B] | The switch designates a port as PortStatesEnum.BROWSING |
| | based on the port priority selection mechanism. The |
| | PortStatesEnum.BROWSING port sends a single |
| | MessageStatesEnum.REQUEST message and waits for a |
| | response (PortStatesEnum.AWAITING RESPONSE) from the |
| | peer port. |
| AWAITING_RESPONSE [AR] | The port listens for incoming messages and sets its state to |
| | PortStatesEnum.DESIGNATED_PORT or |
| | PortStatesEnum.REJECTED depending on the message |
| | received. Since the switch is already non- |
| | SwitchStatesEnum.IDLE (either root or received a message), any |
| | incoming MessageStatesEnum.REQUEST messages are replied |
| | to with MessageStatesEnum.RESPONSE_REJECT. |
| DESIGNATED_PORT [DP] | The port is marked as PortStatesEnum.DESIGNATED_PORT if |
| | the peer port accepted the connection and replied with |
| | MessageStatesEnum.RESPONSE_ACCEPT message. |
| REJECTED [R] | The port is marked as PortStatesEnum.REJECTED, if the peer |
| | port did not accept the connection and replied with |
| | MessageStatesEnum.RESPONSE_REJECT message. |
| ROOT_PORT [RP] | The port is designated as PortStatesEnum.ROOT_PORT if it |
| | received the MessageStatesEnum.REQUEST message while the |
| | switch was SwitchStatesEnum.IDLE. The port may be |
| | SwitchStatesEnum.REJECTED in the pruning phase if the tree |
| | branch represented by the switch is not a terminal branch. |

TABLE 11 provides a list of the message types exchanged between switches during the autoconfiguration protocol execution. The autoconfiguration protocol involves 3 states (log 2 (3)=1.58 bits) per message.

TABLE 11

| Message State | |
|---|---|
| [MessageStatesEnum] | Description |
| REQUEST | This message is sent by a switch on a descending path during |
| | network exploration (Spanning Tree Protocol). It triggers an IDLE |
| | peer switch to enter the SwitchStatesEnum.BROWSING state |
| | that begins the autoconfiguration procedure at the peer switch. |
| RESPONSE_ACCEPT | If a peer switch that received a MessageStatesEnum.REQUEST |
| | is in the IDLE state, it triggers the descent path on its other |
| | switches, and responds with a |
| | MessageStatesEnum.RESPONSE_ACCEPT, informing the peer |
| | switch once a terminal-branch is identified on the ascending path. |
| RESPONSE_REJECT | If a peer switch that received a MessageStatesEnum.REQUEST |
| | is already actively participating in the aggregation tree; it replies |
| | with a MessageStatesEnum.RESPONSE_REJECT message. |
| | This prevents cycles from being created in the aggregation tree. |
| | Alternatively, if a switch detects that it represents a non-terminal |
| | branch, it sends this message on the ascending path to prune the |
| | branch from the aggregation tree. |

The following also provides pseudocode for reduction signals required for Switch FSM logic. As will be understood, the following operations can be implemented using asynchronous logic circuits. This is shown with the following pseudocode in TABLE 12:

```
TABLE 12
def all_ports_configured_reduction(switch, virtual_channel):
  all_ports_configured = True
  # This loop can be handled in parallel as an asynchronous aggregation
  # block with individual signals coming from all ports.
  num_ports = len(switch.ports)
  for port_id in range(num_ports):
    port = switch.ports[port_id]
    if port.state[virtual_channel] == PortStatesEnum.IDLE:
      all_ports_configured = False
      break
  return all_ports_configured
def any_port_designated_reduction(switch, virtual_channel):
  any_port_designated = False
  # This loop can be handled in parallel as an asynchronous aggregation
  # block with individual signals coming from all ports.
  num_ports = len(switch.ports)
  for port_id in range(num_ports):
    port = switch.ports[port_id]
    if port.state[virtual_channel] == PortStatesEnum.DESIGNATED_PORT:
      any_port_designated = True
      break
  return any_port_designated
def root_port_id_reduction(switch, virtual_channel):
  # This function returns the ID of a root port if one is present.
  # Since the root port ID once established does not change, it can be
  # memorized. Formulate this as a function instead of memory, because the
  # port states are already shared for the above reductions, and need to be
  # refreshed at every cycle.
  root_port_id = None
  # This loop can be handled in parallel as an asynchronous aggregation
  # block with individual signals coming from all ports.
  num_ports = len(switch.ports)
  for port_id in range(num_ports):
    port = switch.ports[port_id]
    if port.state[virtual_channel] == PortStatesEnum.ROOT_PORT:
      root_port_id = port_id
      break
  return root_port_id
```

### Example Implementation Methods

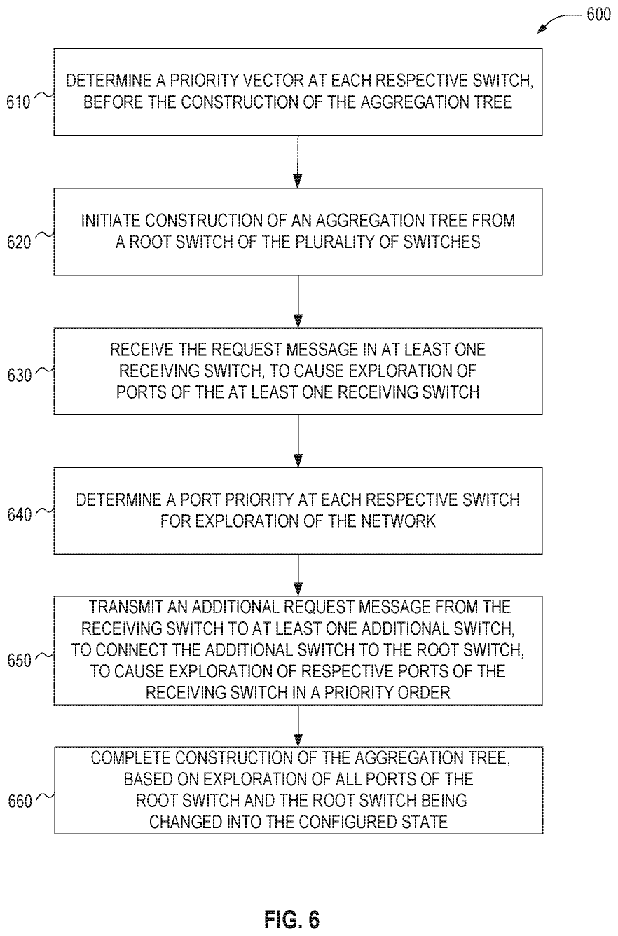

FIG. 6 illustrates a flowchart 600 of a method for constructing an aggregation tree in a network of switches according to some examples of the present disclosure. In an example, the method is performed within a device that includes an interconnect establishing a network and circuitry providing a plurality of switches with corresponding ports, where the plurality of switches are communicatively coupled to one another via the interconnect.

The aggregation tree constructed by the method defines a direction and order of data flow for collective communication operations in the device, such as allreduce operations. The method includes six operations 610, 620, 630, 640, 650, and 660, described below in the sequence depicted. However, additional operations can be used to implement other aspects of the approaches discussed above (e.g., consistent with the pseudocode listed above).

At operation 610, a priority vector is determined at each respective switch of the plurality of switches, before the construction of the aggregation tree. Operation 610 is performed by transmitting, from each terminal switch, a broadcast request message on each enabled port of the respective switch, and recording, at the respective switch, identifiers of the ports as entries of the priority vector in an order in which broadcast request messages are received. Because the broadcast request messages originate from the terminal switches simultaneously and propagate through the network, the order in which a respective port receives a broadcast request message approximates the relative distance from that port to a nearest terminal switch. The port that receives a broadcast request message earliest is recorded as the highest-priority entry of the priority vector, and the port that receives a broadcast request message latest is recorded as the lowest-priority entry. In some examples, the priority vector is a Steiner Distance Priority Vector, with entries that approximate a direction toward a nearest terminal switch.

Operation 610 establishes the priority vector at every switch prior to operation 620, so that the subsequent network exploration can proceed in an order informed by the recorded priorities. However, operation 610 may execute concurrently across the plurality of switches, with each switch independently recording its own priority vector entries as broadcast request messages arrive on its ports.

At operation 620, construction of an aggregation tree is initiated from a root switch of the plurality of switches, using a request message. The root switch is designated, for example, by software or by a higher-level hardware protocol, which places the root switch into a state that begins propagation of the request message on the descending path of the aggregation tree. Operation 620 begins the exploration of the network outward from the root switch toward the terminal switches.

At operation 630, the request message is received in at least one receiving switch, to cause exploration of ports of the at least one receiving switch. Upon receiving the request message, the receiving switch marks the port on which the request message arrived and begins exploring its remaining ports to extend the aggregation tree toward additional switches. The receiving switch is changed into a configured state or a rejected state upon exploration of all ports of the receiving switch. The receiving switch is changed into the configured state if the receiving switch is a terminal switch or has at least one designated port, and is changed into the rejected state if the receiving switch is not a terminal switch and does not have at least one designated port. The rejected state corresponds to pruning a branch of the network that does not lead to a terminal switch, so that the ports along that branch are not retained in the aggregation tree.

At operation 640, a port priority is determined at each respective switch for exploration of the network. The port priority is determined for a respective port of a respective switch from an occupancy value of the respective port and a priority value of the respective port. The port priority is determined by computing, for each port of the respective switch, a score as a function of the occupancy value of that port and the priority value of that port, where the occupancy value represents a number of aggregation trees assigned to that port, and selecting a port of the respective switch having a minimum score. In some examples, the priority value of the respective port is taken from the priority vector determined at operation 610, such that a port directed toward a nearer terminal switch (or terminal node) contributes a score that favors selection of that port. The occupancy value increases as additional aggregation trees are assigned to a port, such that a port already carrying aggregation trees is deferred relative to a less-occupied port. In some examples, the score is computed by multiplying the occupancy value by a number of ports of the respective switch to apply a round-robin ordering among ports of equal occupancy, and offsetting the product by the priority value, so that among ports of equal occupancy the port directed toward the nearest terminal switch (or terminal node) is selected first. The port priority produced at operation 640 is used by an aggregation tree construction protocol at the respective switch to set the priority order in which the exploration occurs in the respective ports of the respective switch.

At operation 650, an additional request message is transmitted from the receiving switch to at least one additional switch, to connect the additional switch to the root switch, based on exploring respective ports of the receiving switch in a priority order. The priority order in which the ports of the receiving switch are explored is set by the port priority determined at operation 640. The additional switch is changed into the configured state or the rejected state upon exploration of all ports of the additional switch, under the same conditions described for the receiving switch at operation 630. By transmitting the additional request message in the priority order, the method explores the network in a depth-first manner, extending a path through ports directed toward nearer terminal switches (or terminal nodes) and toward less-occupied links before consuming additional ports of a given switch.

Operations 630, 640, and 650 are performed iteratively as the exploration propagates through the network. Each additional switch that receives the additional request message at operation 650 becomes a receiving switch for a subsequent iteration of operation 630, determines its own port priority at operation 640, and transmits a further additional request message at operation 650 to a further additional switch. Operation 640 is therefore performed at each respective switch each time that switch selects a next port to explore, rather than a single time, so that the priority order reflects the occupancy value and priority value applicable at the time of each port selection. When a switch reaches a corner of the network from which no unexplored port is available, the exploration retracts along the path through the marked ports, and branches that do not lead to a terminal switch (terminal switch) are pruned by changing the corresponding switches into the rejected state. The iteration continues until the request message and the additional request messages have explored the reachable ports of the network, and the resulting acceptances and rejections have propagated back toward the root switch.

At operation 660, construction of the aggregation tree is completed, based on exploration of all ports of the root switch and the root switch being changed into the configured state. When all ports of the root switch are in a final state, and the root switch is changed into the configured state, the aggregation tree for the network is complete, and the configured state of the root switch can be read by software or a higher-level protocol to indicate that the aggregation tree has been identified.

In some examples, the method is performed independently for each of a plurality of aggregation trees, where each aggregation tree corresponds to a respective virtual channel. After completing construction of one aggregation tree at operation 660, the method may be repeated from operation 620 for a next virtual channel, using the same priority vector determined at operation 610. The occupancy value used at operation 640 reflects the number of aggregation trees already assigned to each port from previously constructed virtual channels, such that each successively constructed aggregation tree is steered toward less-occupied ports to limit overlap among the aggregation trees. In other examples, the construction of the aggregation trees for the plurality of virtual channels is performed concurrently.

In some examples, each respective port of each respective switch uses a per-port finite state machine to track respective states of the respective port, and each respective switch uses a per-switch finite state machine to track respective states of the respective switch. The configured state and the rejected state described in connection with operations 630, 650, and 660 correspond to states of the per-switch finite state machine, and the designated port and the marked port correspond to states of the per-port finite state machine.

### Additional Implementation Notes and Examples

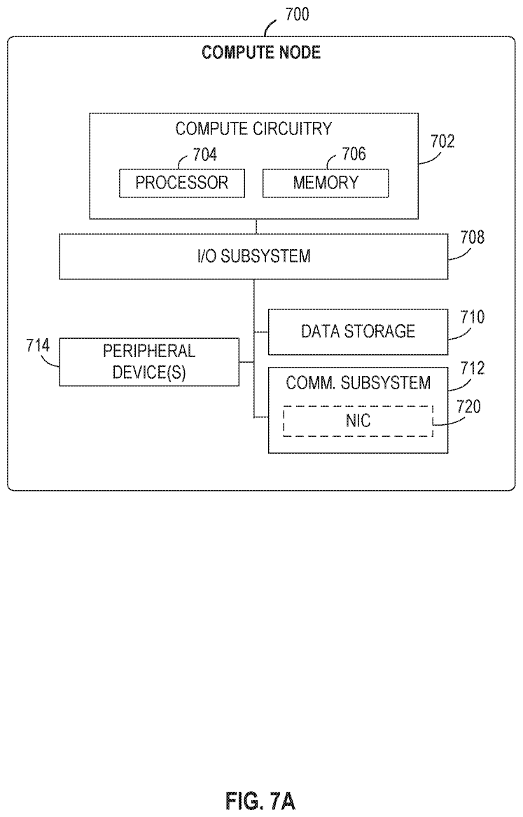

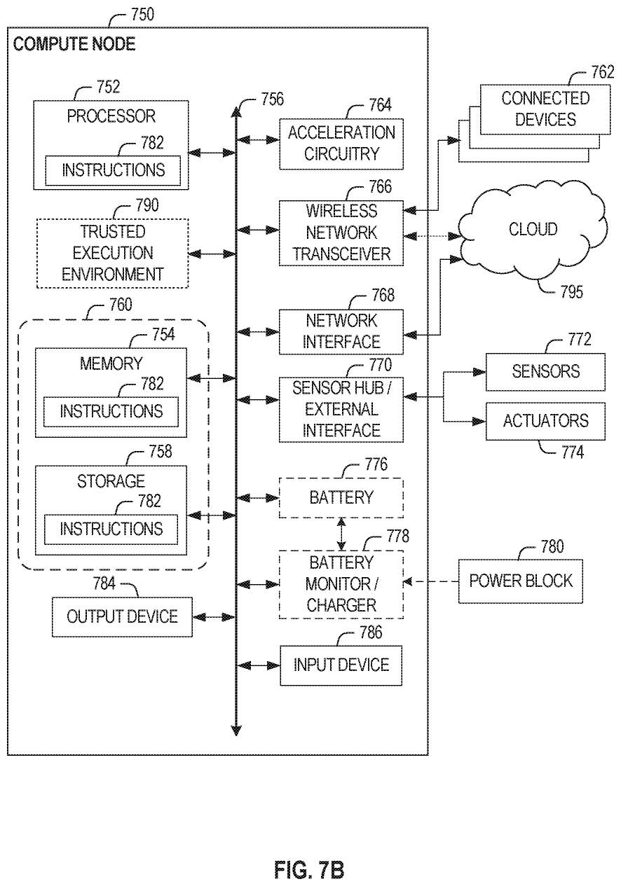

Any of the computing nodes or devices used to implement the aforementioned techniques may be implemented based on the components of a compute node as depicted in FIGS. 7A and 7B. Respective compute nodes may be embodied as a type of device, appliance, computer, or other “thing” capable of communicating with other edge, networking, or endpoint components. For example, a compute device may be embodied as a robot, a robot control system, a personal computer, a server, a mobile computing device, a smart appliance, an in-vehicle compute system (e.g., a navigation system), a self-contained device having an outer case, shell, etc., or other device or system capable of performing the described functions.

In the simplified example depicted in FIG. 7A, a compute node 700 includes a compute engine (also referred to herein as “compute circuitry”) 702, an input/output (I/O) subsystem 708, a data storage device 710, a communication circuitry 712 subsystem, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special-purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation, such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data, such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems, depending on, for example, the type of compute node 700.

The communication circuitry 712 may be embodied as any communication circuit, device, or collection thereof, capable of enabling communications over a network between the compute circuitry 702 and another compute device (e.g., a gateway of an implementing computing system). The communication circuitry 712 may be configured to use one or more communication technologies (e.g., wired or wireless communications) and associated protocols (e.g., a cellular networking protocol such as a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., a gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, or other levels.

Additionally, in some examples, a respective compute node 700 may include one or more peripheral devices 714. Such peripheral devices 714 may include any type of peripheral device found in a compute device or server, such as audio input devices, a display, other input/output devices, interface devices, and/or other peripheral devices, depending on the particular type of the compute node 700. In further examples, the compute node 700 may be embodied by a respective compute node (whether a client, gateway, or aggregation node) in a computing system or like forms of appliances, computers, subsystems, circuitry, or other components.

In a more detailed example, FIG. 7B illustrates a block diagram of an example of components that may be present in a computing node 750 for implementing the techniques (e.g., operations, processes, methods, and methodologies) described herein. This computing node 750 provides a closer view of the respective components of node 700 when implemented as or as part of a computing device (e.g., as a mobile device, a base station, server, gateway, etc.). The computing node 750 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 750, or as components otherwise incorporated within a chassis of a larger system.

The computing node 750 may include processing circuitry in the form of a processor 752, which may be a microprocessor, a multi-core processor, a multithreaded processor, an ultra-low voltage processor, an embedded processor, an xPU/DPU/IPU/NPU, special-purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number of other processors may be used, such as those available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd., or a customer thereof, or their licensees or adopters. The processors may include units such as an A5-A19 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types, such as single die package (SDP), dual die package (DDP), or quad die package (QDP). These devices, in some examples, may be directly soldered onto a motherboard to provide a lower profile solution, while in other examples, the devices are configured as one or more memory modules that in turn couple to the motherboard by a given connector. Any number of other memory implementations may be used, such as other types of memory modules, e.g., dual inline memory modules (DIMMs) of different varieties, including but not limited to microDIMMs or MiniDIMMs.

To provide for persistent storage of information, such as data, applications, operating systems, and so forth, a storage 758 may also be coupled to the processor 752 via the interconnect 756. In an example, the storage 758 may be implemented via a solid-state disk drive (SSD). Other devices that may be used for the storage 758 include flash memory cards, such as Secure Digital (SD) cards, microSD cards, extreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low-power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such as resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI Express (PCIe), or any number of other technologies. The interconnect 756 may be a proprietary bus, for example, used in an SoC-based system. Other bus systems may be included, such as an Inter-Integrated Circuit (I2C) interface, a Serial Peripheral Interface (SPI) interface, point-to-point interfaces, and a power bus, among others.

The interconnect 756 may couple the processor 752 to a transceiver 766, for communications with the connected devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at different ranges. For example, the computing node 750 may communicate with close devices, e.g., within about 7 meters, using a local transceiver based on Bluetooth Low Energy (BLE), or another low-power radio, to save power. More distant connected devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the cloud 795 via local or wide area network protocols. The wireless network transceiver 766 may be a low-power wide-area (LPWA) transceiver that follows the IEEE 802.15.4, or IEEE 802.15.4g standards, among others. The computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification, may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the cloud 795 or to other devices, such as the connected devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components (circuitry 764, transceiver 766, NIC 768, or interface 770). Accordingly, in various examples, applicable means for communicating (e.g., receiving, transmitting, etc.) may be embodied by such communications circuitry.

The computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the computing node 750 to actuators 774, such as power switches, valve actuators, an audible sound generator, a visual warning device, and the like.

In some optional examples, various input/output (I/O) devices may be present within or connected to the computing node 750. For example, a display or other output device 784 may be included to show information, such as sensor readings or actuator position. An input device 786, such as a touch screen or keypad, may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 750. A display or console hardware, in the context of the present system, may be used to provide output and receive input of a computing system; to manage components or services of a computing system; identify a state of a computing component or service; or to conduct any other number of management or administration functions or service use cases.

A battery 776 may power the computing node 750, although, in examples in which the computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix, Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

In an example, the instructions 782 provided via the memory 754, the storage 758, or the processor 752 may be embodied as a non-transitory, machine-readable medium 760 (also referred to as a device-readable medium or storage medium) including code to direct the processor 752 to perform electronic operations in the computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the computing node 750 through the TEE 790 and the processor 752.

In further examples, a machine-readable medium also includes any tangible medium that is capable of storing, encoding, or carrying instructions for execution by a machine and that causes the machine to perform any one or more of the methodologies of the present disclosure or that is capable of storing, encoding, or carrying data structures utilized by or associated with such instructions. A “machine-readable medium” thus may include, but is not limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, decrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations that, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations, including over different storage devices, and may exist, at least partially, merely as electronic signals on a system or network. The components or modules may be passive or active, including agents operable to perform desired functions.

Additional examples of the presently described method, system, and device embodiments include the following non-limiting implementations provided in the claims and/or drawings. Each of the following non-limiting examples may stand on its own or may be combined in any permutation or combination with any one or more of the other examples provided below or throughout the present disclosure.

Example 1 is a device, comprising: an interconnect to establish a network; and circuitry providing a plurality of switches with corresponding ports, the plurality of switches communicatively coupled to one another via the interconnect, with the circuitry configured, arranged, and/or structured to: initiate construction of an aggregation tree from a root switch of the plurality of switches, using a request message, the aggregation tree to define a direction and order of data flow for collective communication operations in the device; receive the request message in at least one receiving switch, wherein the receiving switch is changed into a configured state or a rejected state upon exploration of all or substantially all ports of the receiving switch; transmit an additional request message from the receiving switch to at least one additional switch, to connect the additional switch to the root switch, based on exploring respective ports of the receiving switch in a priority order, wherein the additional switch is changed into the configured state or the rejected state upon exploration of all or substantially all ports of the additional switch; and complete construction of the aggregation tree, based on exploration of all or substantially all ports of the root switch and the root switch being changed into the configured state.

In Example 2, the subject matter of Example 1 optionally includes subject matter wherein a respective port (e.g., each respective port) of a respective switch (e.g., each respective switch) uses a per-port finite state machine to track respective states of the respective port, and

wherein a respective switch (e.g., each respective switch) uses a per-switch finite state machine to track respective states of the respective switch.

In Example 3, the subject matter of any one or more of Examples 1-2 optionally includes subject matter wherein the priority order in which the ports of a respective switch are explored is determined by at least one of: a score computed for a port (e.g., each port) of the respective switch, or a priority value associated with a port (e.g., each port) of the respective switch, wherein a port having a lowest score or a highest priority is explored first.

In Example 4, the subject matter of any one or more of Examples 1-3 optionally includes subject matter wherein the receiving switch or the additional switch is changed into a configured state upon exploration of all ports of the receiving switch or the additional switch if the switch is a terminal node or has at least one designated port, and wherein the receiving switch or the additional switch is changed into a rejected state if the switch is not a terminal node and does not have at least one designated port.

In Example 5, the subject matter of any one or more of Examples 1~4 optionally includes the circuitry further to: determine, before the construction of the aggregation tree, a respective priority vector for a respective switch (e.g., each switch) of the plurality of switches with operations that: transmit, from a terminal switch or switches (e.g., each terminal switch), a broadcast request message on an enabled port or ports (e.g., each enabled port) of the respective switch; and record, at the respective switch, identifiers of the ports as entries of the priority vector, in an order in which broadcast request messages are received.

In Example 6, the subject matter of Example 5 optionally includes subject matter wherein the priority order, in which the exploration occurs in the respective ports of the respective switch, is based on the priority vector.

In Example 7, the subject matter of Example 6 optionally includes subject matter wherein the priority vector is a Steiner Distance Priority Vector, with entries that approximate a direction toward a nearest terminal node.

In Example 8, the subject matter of any one or more of Examples 1-7 optionally includes the circuitry further to: determine a port priority at a respective switch (e.g., each switch) for exploration of the network, the port priority being determined for a respective port of a respective switch from an occupancy value of the respective port and a priority value of the respective port.

In Example 9, the subject matter of Example 8 optionally includes subject matter wherein the port priority is used by an aggregation tree construction protocol at the respective switch to set a priority order in which the exploration occurs in the respective ports of the respective switch.

In Example 10, the subject matter of Example 9 optionally includes subject matter wherein to identify the port priority of the respective switch includes operations to: compute, for a port (e.g., each port) of the respective switch, a score as a function of the occupancy value of that port and the priority value of that port, wherein the occupancy value represents a number of aggregation trees assigned to that port; and select a port of the respective switch having a minimum score.

In Example 11, the subject matter of any one or more of Examples 1-10 optionally includes subject matter wherein the device is a semiconductor device providing a central processing unit (CPU), graphics processing unit (GPU), system-on-chip, or system-in-package semiconductor device, wherein the interconnect provides a network-on-chip.

Example 12 is a device, comprising: circuitry; and a memory device including instructions embodied thereon, wherein the instructions, which when executed by the circuitry, configure the processing circuitry to perform operations for performing or initiating a collective communication autoconfiguration for networked switches, in accordance with Examples 1 to 11 or other examples disclosed herein.

Example 13 is a method, comprising a plurality of operations executed with circuitry and memory of a device, to perform operations for performing or initiating a collective communication autoconfiguration for networked switches, in accordance with Examples 1 to 11 or other examples disclosed herein.

Example 14 is a non-transitory machine-readable storage medium including instructions, wherein the instructions, when executed by a circuitry of a device, cause the circuitry to perform operations for performing or initiating a collective communication autoconfiguration for networked switches, in accordance with Examples 1 to 11 or other examples disclosed herein.

Example 15 is an apparatus, comprising respective means for performing or initiating a collective communication autoconfiguration for networked switches, in accordance with Examples 1 to 11 or other examples disclosed herein.

Example 16 is a network comprising respective devices and device communication mediums for performing or initiating a collective communication autoconfiguration for networked switches, in accordance with Examples 1 to 11 or other examples disclosed herein.

Example 17 is a system comprising respective components arranged or configured to perform any of the operations or techniques discussed herein, in accordance with Examples 1 to 16 or other examples disclosed herein.

Example 18 is a method to perform any of the operations or techniques discussed herein, in accordance with Examples 1 to 16 or other examples disclosed herein.

Although these implementations have been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read-only memories (ROMs), and the like.

What is claimed is:

1. A device, comprising:
an interconnect to establish a network; and
circuitry providing a plurality of switches with corresponding ports, the plurality of switches communicatively coupled to one another via the interconnect, and the circuitry to:
initiate construction of an aggregation tree from a root switch of the plurality of switches, using a request message, the aggregation tree to define a direction and order of data flow for collective communication operations in the device;
receive the request message in at least one receiving switch, wherein the receiving switch is changed into a configured state or a rejected state upon exploration of ports of the receiving switch;
transmit an additional request message from the receiving switch to at least one additional switch, to connect the additional switch to the root switch, based on exploring respective ports of the receiving switch in a priority order, wherein the additional switch is changed into the configured state or the rejected state upon exploration of ports of the additional switch; and
complete construction of the aggregation tree, based on exploration of ports of the root switch and the root switch being changed into the configured state.

2. The device of claim 1, wherein a respective port of a respective switch uses a per-port finite state machine to track respective states of the respective port, and wherein a respective switch uses a per-switch finite state machine to track respective states of the respective switch.

3. The device of claim 1, wherein the priority order in which the ports of a respective switch are explored is determined by at least one of: a score computed for a port of the respective switch, or a priority value associated with a port of the respective switch, wherein a port having a lowest score or a highest priority is explored first.

4. The device of claim 1, wherein the receiving switch or the additional switch is changed into a configured state upon exploration of all ports of the receiving switch or the additional switch if the switch is a terminal node or has at least one designated port, and wherein the receiving switch or the additional switch is changed into a rejected state if the switch is not a terminal node and does not have at least one designated port.

5. The device of claim 1, the circuitry further to:
determine, before the construction of the aggregation tree, a respective priority vector for a respective switch of the plurality of switches with operations that:
transmit, from terminal switches, a broadcast request message on enabled ports of the respective switch; and
record, at the respective switch, identifiers of the ports of that respective switch as entries of the priority vector, in an order in which broadcast request messages are received.

6. The device of claim 5, wherein the priority order, in which the exploration occurs in the respective ports of the respective switch, is based on the priority vector.

7. The device of claim 6, wherein the priority vector is a Steiner Distance Priority Vector, with entries that approximate a direction toward a nearest terminal node.

8. The device of claim 1, the circuitry further to:
determine a port priority at a respective switch for exploration of the network, the port priority being determined for a respective port of a respective switch from an occupancy value of the respective port and a priority value of the respective port.

9. The device of claim 8, wherein the port priority is used by an aggregation tree construction protocol at the respective switch to set a priority order in which the exploration occurs in the respective ports of the respective switch.

10. The device of claim 9, wherein to identify the port priority of the respective switch includes operations to:
compute, for a port of the respective switch, a score as a function of the occupancy value of that port and the priority value of that port, wherein the occupancy value represents a number of aggregation trees assigned to that port; and
select a port of the respective switch having a minimum score.

11. The device of claim 1, wherein the device is a semiconductor device providing a central processing unit (CPU), graphics processing unit (GPU), system-on-chip, or system-in-package semiconductor device, wherein the interconnect provides a network-on-chip.

12. A non-transitory machine-readable storage medium comprising instructions that, when executed by circuitry of a device having a plurality of switches, cause the device to perform operations that:
initiate construction of an aggregation tree from a root switch of the plurality of switches, using a request message, the aggregation tree to define a direction and order of data flow for collective communication operations in the device for communication in a network;
receive the request message in at least one receiving switch, wherein the receiving switch is changed into a configured state or a rejected state upon exploration of ports of the receiving switch;
transmit an additional request message from the receiving switch to at least one additional switch, to connect the additional switch to the root switch, based on exploring respective ports of the receiving switch in a priority order, wherein the additional switch is changed into the configured state or the rejected state upon exploration of ports of the additional switch; and
complete construction of the aggregation tree, based on exploration of ports of the root switch and the root switch being changed into the configured state.

13. The non-transitory machine-readable storage medium of claim 12, wherein a respective port of a respective switch uses a per-port finite state machine to track respective states of the respective port, and wherein a respective switch uses a per-switch finite state machine to track respective states of the respective switch.

14. The non-transitory machine-readable storage medium of claim 12, wherein the instructions further cause the circuitry to perform operations that:
determine, before the construction of the aggregation tree, a respective priority vector for a respective switch of the plurality of switches with operations that:
transmit, from terminal switches, a broadcast request message on enabled ports of the respective switch; and
record, at the respective switch, identifiers of the ports of that respective switch as entries of the priority vector, in an order in which broadcast request messages are received;
wherein the priority vector is a Steiner Distance Priority Vector, with entries that approximate a direction toward a nearest terminal node.

15. The non-transitory machine-readable storage medium of claim 12, wherein the instructions further cause the circuitry to perform operations that:
determine a port priority at a respective switch for exploration of the network, the port priority being determined for a respective port of a respective switch from an occupancy value of the respective port and a priority value of the respective port.

16. A method, performed with a device comprising circuitry providing a plurality of switches with corresponding ports, the plurality of switches communicatively coupled to one another in a network via an interconnect, and the method comprising:
initiating construction of an aggregation tree from a root switch of the plurality of switches, using a request message, the aggregation tree to define a direction and order of data flow for collective communication operations in the device;
receiving the request message in at least one receiving switch, wherein the receiving switch is changed into a configured state or a rejected state upon exploration of ports of the receiving switch;
transmitting an additional request message from the receiving switch to at least one additional switch, to connect the additional switch to the root switch, based on exploring respective ports of the receiving switch in a priority order, wherein the additional switch is changed into the configured state or the rejected state upon exploration of ports of the additional switch; and
completing construction of the aggregation tree, based on exploration of ports of the root switch and the root switch being changed into the configured state.

17. The method of claim 16, wherein a respective port of a respective switch uses a per-port finite state machine to track respective states of the respective port, and wherein a respective switch uses a per-switch finite state machine to track respective states of the respective switch.

18. The method of claim 16, wherein the receiving switch or the additional switch is changed into a configured state upon exploration of all ports of the receiving switch or the additional switch if the switch is a terminal node or has at least one designated port, and wherein the receiving switch or the additional switch is changed into a rejected state if the switch is not a terminal node and does not have at least one designated port.

19. The method of claim 16, further comprising:
determining, before the construction of the aggregation tree, a respective priority vector for a respective switch of the plurality of switches with operations that:
transmit, from terminal switches, a broadcast request message on enabled ports of the respective switch; and
record, at the respective switch, identifiers of the ports as entries of the priority vector, in an order in which broadcast request messages are received;
wherein the priority vector is a Steiner Distance Priority Vector, with entries that approximate a direction toward a nearest terminal node.

20. The method of claim 16, further comprising:
determining a port priority at a respective switch for exploration of the network, the port priority being determined for a respective port of a respective switch from an occupancy value of the respective port and a priority value of the respective port.
